(19) United States
(12) Patent Application Publication
(10) Pub. No.: US 2016/0085883 A1
(43) Pub. Date: Mar. 24, 2016

(54) Verification System for System Design Consistency

(71) Applicant: Toyota Jidosha Kabushiki Kaisha, Toyota-shi (JP)

(72) Inventors: Shinichi Shiraishi, San Jose, CA (US); Ashlie Benjamin Hocking, Charlottesville, VA (US); Michael Anthony Aiello, Keswick, VA (US); John Charles Knight, Charlottesville, VA (US)

(21) Appl. No.: 14/491,915

(22) Filed: Sep. 19, 2014

(51) Int. Cl. G06F 17/50

(52) U.S. Cl. CPC G06F 17/504

(57) ABSTRACT

An example system is executable by one or more processors to retrieve a development model and a production model; translate the development model and the production model into formal specifications; generate a set of theorems for checking constrained equivalence between the development model and the production model; combine formal specification of the development model, formal specification of the production model, and the set of theorems into a combined specification; and prove the constrained equivalence based on the theorems.

### BACKGROUND

The specification relates to verification system for system design consistency.

In real system development, system design changes occur frequently even when original requirements associated with the system design remain the same. For instance, in a software development, a design is changed in order to reduce memory consumption, to reduce latency, etc. Moreover, in the case of automotive system development with a model-based approach (e.g., using Simulink), an OEM creates a specification model to describe new algorithms and provides it to a supplier as an OEM model. Typically, OEM models are abstract models regardless of the limited precision of software. The supplier usually modifies the given OEM model to make it implementable by software or to improve the performance. The resultant modified OEM model is oftentimes referred to as a supplier model. Because of the modifications made by the supplier to the OEM model, the OEM model and the supplier model sometimes end up being different. Existing testing and simulation methods for verifying equivalence between these models are very costly and require long time to check a large number of different scenarios. In addition, they cannot give 100% guarantee of the equivalence because it is virtually impossible to explore all the possible test case scenarios.

### SUMMARY

According to one innovative aspect of the subject matter described in this disclosure, a system includes one or more processors; models retriever executable by the one or more processors to retrieve, from a non-transitory data storage, a development model and a production model; a translator executable by the one or more processors to translate the development model and the production model into formal specifications; an equivalence theorem generator executable by the one or more processors to generate a set of theorems for checking constrained equivalence between the development model and the production model; a combiner executable by the one or more processors to combine formal specification of the development model, formal specification of the production model, and the set of theorems into a combined specification; and a constrained equivalence verifier executable by the one or more processors to prove the constrained equivalence based on the theorems.

In general, another innovative aspect of the subject matter described in this disclosure may be embodied in methods that include retrieving, by a verification platform from a non-transitory data storage, a development model and a production model; translating, by the verification platform, the development model and the production model into formal specifications; generating, by the verification platform, a set of theorems for checking constrained equivalence between the development model and the production model; combining, by the verification platform, formal specification of the development model, formal specification of the production model, and the set of theorems into a combined specification; and proving, by the verification platform, the constrained equivalence based on the theorems

Other aspects include corresponding methods, systems, apparatus, and computer program products for these and other innovative aspects.

These and other embodiments may each optionally include one or more of the following features and/or operations. For instance, the operations include that proving the constrained equivalence includes proving a theorem establishing the development model and the production model each produces an equivalent output for a particular scenario in response to receiving one or more equivalent inputs; that proving the constrained equivalence based on the theorems includes determining for a theorem, by the verification platform, that one or more inputs to the development model and one or more inputs to the production model are the same or equivalent within a first specified tolerance, determining for the theorem, by the verification platform, that an output of the development model and an output of the production model are the same or equivalent within a second specified tolerance, and determining the theorem as proven responsive to determining that the one or more inputs to the development model and the one or more inputs to the production model are the same or equivalent within the first specified tolerance, and that the output of the development model and the output of the production model are the same or equivalent within the second specified tolerance; approving, by the verification platform, the production model as meeting a particular standard based on proving the constrained equivalence for the development model and the production model; generating, by the verification platform, a proof summary describing for each theorem whether the theorem was proven or un-proven for a particular scenario associated with the theorem; providing, by the verification platform, the proof summary and a status of constrained equivalence for the development model and the production model to a user device associated with a user for display; sending, by the verification platform, a request to a user for providing guidance in proving the constrained equivalence for the development model and the production model; receiving, by the verification platform, user guidance related to proving the constrained equivalence from a user device associated with the user; that proving the constrained equivalence is based on the user guidance; prior to retrieving the development model and the production model, verifying, by the verification platform, compliance of each of the development model and the production model with a set of software requirements; responsive to determining the compliance, storing, by the verification platform, each of the development model and the production model as a verified model in the non-transitory data storage; and verifying the compliance of each of the development model and the production model with the set of software requirements includes receiving, by the verification platform, the set of software requirements, translating, by the verification platform, the set of requirements into a formal specification, translating, by the verification platform, each of the development model and the production model into a formal specification, and comparing, by the verification platform, the formal specification of each of the development model and the production model with the formal specification of the software requirements to determine whether or not each of the development model and the production model complies with the set of software requirements. For instance, the features include that the development model is an OEM model designed by a manufacturer and the production model is a modified OEM model customized by a supplier according to the supplier's need; that each of the theorems is one of a type correctness condition, a lemma, and a predicate; and that the formal specification is a prototype verification system (PVS) specification language including a set of theories.

According to yet another innovative aspect of the subject matter described in this disclosure, a system includes one or more processors; a models verifier executable by the one or more processors to verify compliance of each of a development model and a production model with a set of software requirements and responsive to the compliance being verified, determine each of the development model and the production model as verified and store each verified model in a non-transitory data storage; models retriever executable by the one or more processors to retrieve from the non-transitory data storage, the development model and the production model determined as verified; a translator executable by the one or more processors to translate each of the development model and the production model into a formal specification; an equivalent theorem generator executable by the one or more processors to generate a set of theorems, each of the theorems proving whether the development model and the production model each produces a same or an equivalent output within a first specified tolerance for a particular scenario in response to receiving one or more same or equivalent inputs within a second specified tolerance; a combiner executable by the one or more processors to combine formal specification of the development model, formal specification of the production model, and the set of theorems into a combined specification; and a constrained equivalent verifier executable by the one or more processors to compile the combined specification and determine whether each of the theorems is proven based on whether the development model and the production model each produces a same or an equivalent output within the first specified tolerance, the constrained equivalence verifier is further executable to determine the development model and the production model as exhibiting constrained equivalence based on each of the theorems being proven.

In general, yet another innovative aspect of the subject matter described in this disclosure may be embodied in methods that include verifying, by a verification platform, compliance of each of a development model and a production model with a set of software requirements; responsive to the compliance being verified, determining, by the verification platform, each of the development model and the production model as verified and storing each verified model in a non-transitory data storage; retrieving, by the verification platform from the non-transitory data storage, the development model and the production model determined as verified; translating, by the verification platform, each of the development model and the production model into a formal specification; generating, by the verification platform, a set of theorems, each of the theorems proving whether the development model and the production model each produces a same or an equivalent output within a first specified tolerance for a particular scenario in response to receiving one or more same or equivalent inputs within a second specified tolerance; combining, by the verification platform, formal specification of the development model, formal specification of the production model, and the set of theorems into a combined specification; compiling, by the verification platform, the combined specification and determining whether each of the theorems is proven based on whether the development model and the production model each produces a same or an equivalent output within the first specified tolerance; and determining, by the verification platform, the development model and the production model as exhibiting constrained equivalence based on each of the theorems being proven.

These and other implementations may each optionally further include one or more of the following features. For instance, the features may further include that the development model is an OEM model designed by a manufacturer and the production model is a modified OEM model customized by a supplier according to the supplier's need; that each of the theorems is one of a type correctness condition, a lemma, and a predicate; and that the formal specification is a prototype verification system (PVS) specification language including a set of theories.

The disclosure is particularly advantageous in a number of respects. For example, the technology described herein can give mathematical proof for constrained equivalence of two models. In addition, the technology uses a highly cost-efficient method to promise the assurance of models equivalence and/or their compliance with software requirements. It should be understood that the foregoing advantages are provided by way of example and the technology may have numerous other advantages and benefits.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example verification system for system design consistency.

FIG. 2A is a block diagram illustrating an example computing device.

FIG. 2B is a block diagram of an example verification engine.

FIG. 3 is a flowchart of an example method for verifying constrained equivalence between a development model and a production model.

FIGS. 4A-4C are flowcharts of an example method for verifying constrained equivalence between a development model and a production model.

FIGS. 5A and 5B are flowcharts of an example method for verifying compliance of a model with a set of software requirements.

FIG. 6 is a diagram illustrating an example method for performing constrained equivalence of a development model and a production model.

FIG. 7 is a diagram illustrating an example method for performing software requirements proof and constrained equivalence proof of a development model and a production model.

FIG. 8 illustrates an example method for verifying an example OEM model with one or more software requirements.

FIG. 9 illustrates an example method for verifying an example supplier model with one or more software requirements.

FIG. 10 is a diagram illustrating an example method for constrained equivalence proof of an example OEM model and an example supplier model.

FIGS. 11A and 11B depict an example OEM model and an example supplier model, respectively.

FIG. 11C depicts an example bang-bang controller used by an example OEM model.

FIGS. 12A and 12B depict wheel speed input parameters used by each of the OEM model and supplier model, respectively.

FIGS. 13A and 13B depict an example plot of vehicle and wheel speed versus time and an example plot of relative wheel slip versus time for an example OEM model, respectively.

FIGS. 14A and 14B depict an example plot of vehicle and wheel speed versus time and an example plot of relative wheel slip versus time for an example supplier model, respectively.

FIGS. 15A and 15B depict an example OEM vehicle model and an example supplier vehicle model, respectively.

### DETAILED DESCRIPTION

### Overview

In a model-based software development, a model of a required software component can be built, analyzed, and used to create an implementation of the software component. The model may be developed as part of an overall systems engineering process in which the complete system may be designed. The ability to modify a software component model easily, as part of the systems engineering process during refinement of the complete system design, is one of the major benefits of the model-based software development.

Once a system design has reached the point that engineering moves to detailed design and manufacturing, the model of the software component (also referred to as a development model) can be refined into a production model. This refinement usually requires that the software component model be changed to accommodate differences such as limited precision data, target platform hardware characteristics, and more efficient algorithms. The refinement into the production model is often undertaken by different engineers (e.g., a system developer, a supplier, a producer etc.) and frequently in different companies and/or organizations.

Development models rarely take account of the practical limitations forced by target platforms that must be addressed by production models. For example, development models might use 32-bit integers as a convenience (although not requiring that precision) whereas the target platform used for the production model only supports 16-bit integers. This difference means that the two models may not be identical. In general, such differences are common in engineering.

Typically, equivalence of models is established by testing. However, such equivalence testing often leads to high cost, doubt about the adequacy of the coverage of one or more test cases selected, and failure to provide 100% guarantee of the equivalence. The technology described in this disclosure is based on the concept of constrained equivalence in model-based development and a proof-theory for establishing constrained equivalence of the models.

Two models may exhibit constrained equivalence if either (a) all valid inputs to a first model produce a same output in a second model to within a specified tolerance, or (b) inputs to the second model that are within a specified tolerance of the inputs to the first model produce the same output. In some embodiments, predefined scaling factors and offsets may be used in determining whether two factors are the same.

By way of an example to explain a first type of constrained equivalence, consider the following functions:

$$A ( n ) = \{ \begin{matrix}( n - 32 ) \times 18 , & n > 32 \\ ( 32 - n ) \times 18 , & n \leq 32\end{matrix} \\ B ( x ) = \{ \begin{matrix}( x - 32 ) \times 1.8 , & x > 32 \\ ( 32 - x ) \times 1.8 + 0.001 , & x \leq 32\end{matrix}$$

In the above example, n is an integer (perhaps from a production model) and x is a real number (perhaps from a development model). For all integers (e.g., the domain of A):

|A(n)−10×B(n)|≦0.001

So there is a constrained equivalence between the functions A(n) and B(x), on assumption that the scaling factor of 10 for the output of A is predefined.

By way of another example to explain a second type of constrained equivalence, consider the following functions:

$$A ( n ) = \{ \begin{matrix}true , & n > 31416 \\ false , & n \leq 31416\end{matrix} \\ B ( x ) = \{ \begin{matrix}true , & x > 3.14159265358979 \\ false , & x \leq 3.14159265358979\end{matrix}$$

In the above example, A(n)=B(n÷10000) when n≠31416, and A(n)=B(n÷10000−7.34641E-6) when n=31416, so for all n there exist an m such that abs(n÷10000−m)<1E-5 and A(n)=B(m), on assumption that the scaling factor of 10,000 for the input to A is predefined.

In some embodiments, steps to complete proof of constrained equivalence for two models may include:
1) Translating both the models to PVS specifications using a translator, such as Simulink2PVS.
2) Creating a predicate stating constrained equivalence between the two PVS specifications (including the application of necessary scaling). Quantification in the predicate is over the values of variables that the production model uses, i.e., integers or mappings to the integers.
3) Combining (a) the PVS specifications of both models and (b) the predicate of constrained equivalence.
4) Using a verification system (e.g., PVS verification system) to prove the theorem of constrained equivalence.

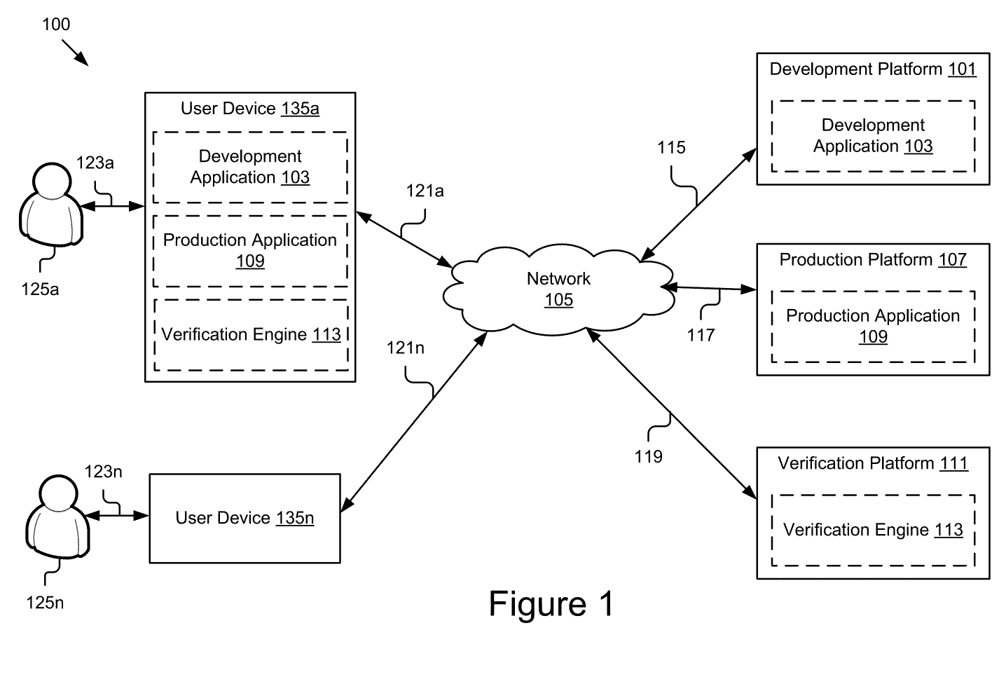

FIG. 1 is a block diagram illustrating an example verification system 100 for system design consistency. The illustrated system 100 includes user devices 135a . . . 135n, a development platform 101, a production platform 107, and a verification platform 111, which are communicatively coupled via a network 105 for interaction with one another. For example, the user devices 135a . . . 135n may be respectively coupled to the network 105 via signal lines 121a . . . 121n. Users 125a . . . 125n can interact (e.g., use, provide input, view results, etc.) with the user devices 135a . . . 135n as indicated by signal lines 123a . . . 123n respectively. The development platform 101 may be coupled to the network 105 via signal line 115. The production platform 107 may be coupled to the network 105 via signal line 117. The verification platform 111 may be coupled to the network 105 via signal line 119. The use of the nomenclature “a” and “n” in the reference numbers indicates that the system 100 may include any number of those elements having that nomenclature.

The network 105 can be a conventional type, wired or wireless, and may have numerous different configurations including a star configuration, token ring configuration, or other configurations. Furthermore, the network 105 may include one or more local area networks (LAN), wide area networks (WAN) (e.g., the Internet), public networks, private networks, virtual networks, and/or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 includes near-field (e.g., Bluetooth®) communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 105 coupled to the user devices 135a . . . 135n, the development platform 101, the production platform 107, and the verification platform 111, in practice one or more networks 105 can be connected to these entities.

The user devices 135a . . . 135n (also referred to individually and collectively as 135) can be computing devices having data processing and communication capabilities. In some embodiments, a user device 135 may include a memory and a processor, and various other components. For example, the user device 135 may be a laptop computer, a desktop computer, a tablet computer, a mobile telephone, a personal digital assistant (PDA), a mobile email device or any other electronic device capable of processing information and accessing a network 105. The user devices 135 may be communicatively coupled to the network 105 via signal lines 121a . . . 121n (also referred to individually and collectively as 121). In some embodiments, the users 125a . . . 125n (also referred to individually and collectively as 125) can interact with the user devices 135 via signal lines 123a . . . 123n, respectively. In some embodiments, a user device 135 can send and receive data to and from one or more of the development platform 101, the production platform 107, and/or the verification platform 111. For example, the user device 135 can receive data describing constrained equivalence status for a development model and a production model from the verification platform 111 and present the information to the user 125 via a user interface. While two or more user devices 135 are depicted in FIG. 1, the system 100 may include any number of user devices 135. In addition, the user devices 135a . . . 135n may be the same or different types of computing devices.

As depicted, a user device 135 contains one or more instances of the development application 103, the production application 109, and/or the verification engine 113. Each of these instances 103, 109, and/or 113 is shown in a broken line to indicate that the instance may or may not be included in the user device 135. For example, in one embodiment, the development application 103 may be stored locally in the user device 135 and the user 125 may use the development application 103 to develop or design a development model. In another embodiment, the development application 103 can only be accessed from the development platform 101 via the network 105. Other variations are also possible and contemplated.

The development platform 101, the production platform 107, and the verification platform 111 are computing devices having data processing, storing, and communication capabilities. For example, development platform 101, the production platform 107, and the verification platform 111 may include one or more hardware servers, virtual servers, server arrays, storage devices and/or systems, etc., which may be networked via the network 105 for cooperation and communication with one another. In some embodiments, development platform 101, the production platform 107, and the verification platform 111, may be implemented using cloud-based architectures where one or more computer functions are performed by remote computing systems and devices at the request of a local computer device, although further implementations are also contemplated where the development platform 101, the production platform 107, and the verification platform 111 are implemented using local hardware and/or software resources or a combination of the foregoing.

As depicted, the development platform 101 may include a development application 103. The development application 103 can be software and/or hardware logic for developing an OEM or a development model. For example, the development application may be MATLAB® software for developing a Simulink OEM model for a vehicle manufacturer. In some embodiments, an instance of the development application 103 may be included in another entity coupled to the network 105, such as a user device 135, in addition to or in place of being included in the development platform 101.

As depicted, the production platform 107 may include a production application 109. The production application 109 can be software and/or hardware logic for customizing a development model according to a user software and/or hardware needs. For example, the production application may be MATLAB® software for developing a Simulink supplier model based on a Simulink OEM model for a vehicle supplier. In some embodiments, an instance of the production application 109 may be included in another entity coupled to the network 105, such as a user device 135, in addition to or in place of being included in the production platform 107.

As depicted, the verification platform 111 may include a verification engine 113. The verification engine 113 can be software and/or hardware logic for verifying constrained equivalence between a development model and a production model. For example, the verification engine 113 may be a PVS verification system for verifying constrained equivalence between a Simulink OEM model and a Simulink supplier model. In some embodiments, an instance of the verification engine 113 may be included in another entity coupled to the network 105, such as a user device 135, in addition to or in place of being included in the verification platform 111.

Additional structure, acts, and/or functionality of the development platform 101, the production platform 107, and the verification platform 111 are described in further detail elsewhere herein.

### Example Computing Device 200

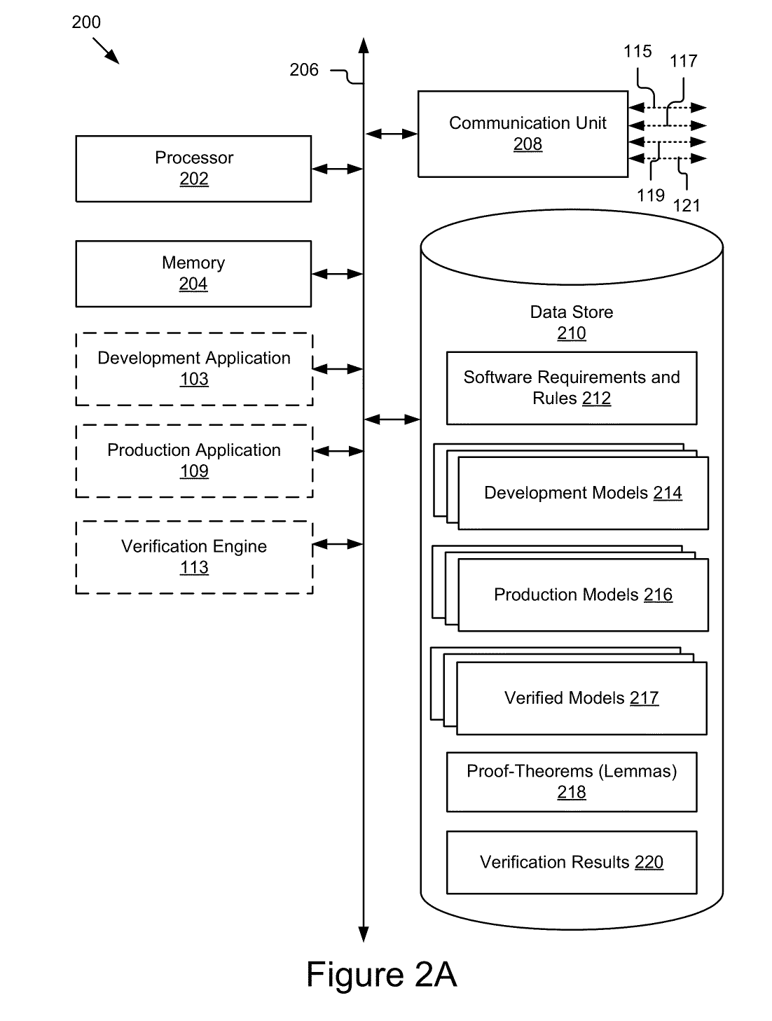

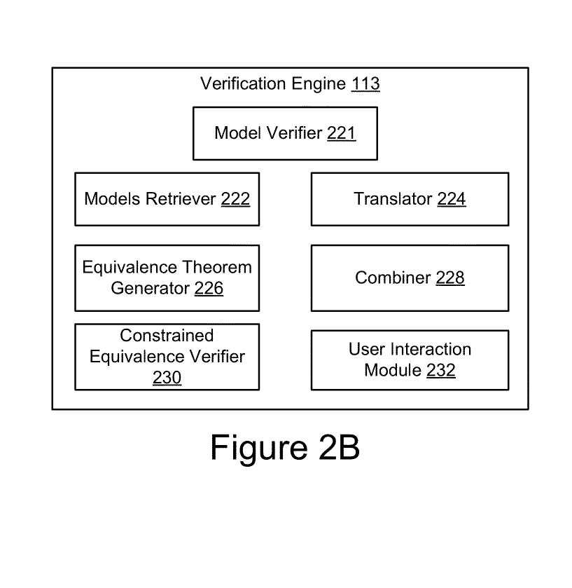

FIG. 2A is a block diagram of an example computing device 200, which may be representative of a computing device included in the development platform 101, the production platform 107, the verification platform 111, and/or the user device 135. As depicted, the computing device 200 may include a processor 202, a memory 204, a communication unit 208, a data store 210, and one or more of the development application 103, the production application 109, and the verification engine 113, which may be communicatively coupled by a communication bus 206.

Depending upon the implementation, the computing device 200 may include differing components. For instance, in a development implementation, the computing device 200 may include the development application 103. In a production implementation, the computing device 200 may include the production application 107. In a verification implementation, the computing device 200 may include the verification engine 113. It should be understood that the above implementations are provided by way of example and numerous further implementations are contemplated and possible.

The processor 202 can include one or more processing units, such as an arithmetic logic unit, a microprocessor, a general purpose controller, a specialized processing unit, or some other processor array to perform computations and provide electronic display signals to a display device (not shown). The processor 202 can process data signals and may include various computing architectures including a complex instruction set computer (CISC) architecture, a reduced instruction set computer (RISC) architecture, an architecture implementing a combination of instruction sets, etc. In some embodiments, the processor 202 may be one of a general processor, a special-purpose processor such as an application specific integrated circuit (ASIC), a field programmable gate array (FPGA), a digital signal processor (DSP), a network processor, or the like. Although FIG. 2A depicts a single processor 202, multiple processors 202 may be included. Other processors, operating systems, sensors, displays and physical configurations are possible.

The memory 204 includes one or more non-transitory computer-readable media for storing instructions and/or data that can be executed by the processor 202. The instructions and/or data may include code for performing the techniques described herein. In some embodiments, the memory 204 can store the development application 103, the production application 109, and/or the verification engine 113. The memory 204 may include a dynamic random access memory (DRAM) device, a static random access memory (SRAM) device, embedded memory, flash memory, or some other memory device. In some embodiments, the memory 204 can also include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The bus 206 can include a communication bus for transferring data between components of a computing device or between computing devices, a network bus system including the network 105 or portions thereof, a processor mesh, a combination thereof, etc. In some implementations, the development application 103, the production application 109, and the verification engine 113 may cooperate and communicate with each other via a software communication mechanism implemented in association with the bus 206. The software communication mechanism can include and/or facilitate, for example, inter-process communication, local function or procedure calls, remote procedure calls, network-based communication, secure communication, etc.

The communication unit 208 may include one or more interface devices for wired and wireless connectivity with the network 105 and the other entities and/or components of the system 100 including, for example, the user devices 135, the development platform 101, the production platform 107, and the verification platform 111. For instance, the communication unit 208 may include, but is not limited to, CAT-type interfaces; wireless transceivers for sending and receiving signals using Wi-Fi™; Bluetooth®, cellular communications, etc.; USB interfaces; various combinations thereof; etc. The communication unit 208 may be coupled to the network 105 via the signal lines 115, 117, 119, and 121. In some implementations, the communication unit 208 can link the processor 202 to the network 105, which may in turn be coupled to other processing systems. The communication unit 208 can provide other connections to the network 105 and to other entities of the system 100 using various standard communication protocols, including, for example, those discussed elsewhere herein.

The data store 210 is an information source for storing and providing access to data. In some implementations, the data store 210 may be coupled to the components 202, 204, 208, 103, 109, and/or 113 of the computing device 200 via the bus 206 to receive and provide access to data. Non-limiting examples of the types of data stored by the data store 210 may include software requirements and rules 212 (e.g., syntaxes, variable declarations, rule types and conditions, software standards, buffer overflow checks, division by zero checks, etc.), development models 214 (e.g., set of OEM models designed by one or more manufacturers), production models 216 (e.g., set of customized OEM models modified by one or more suppliers according to their needs), verified models 217 (e.g., set of development and production models that have been verified and determined to be complied with the set of software requirements and rules 212), proof-theorems 218 (e.g., small lemmas, predicates, and/or type-correctness conditions for checking constrained equivalence between a development model 214 and a production model 216), and/or verification results 220 (e.g., results describing compliance status of one or more development models 214 with the software requirements and rules 212, results describing compliance status of one or more production models 214 with the software requirements and rules 212, results describing constrained equivalence status between a development model and a production model, etc.).

The data store 210 can include one or more non-transitory computer-readable mediums for storing the data. In some implementations, the data store 210 may be incorporated with the memory 204 or may be distinct therefrom. In some implementations, the data store 210 may include a database management system (DBMS). For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

### Example Verification Engine 113

FIG. 2B is a block diagram of an example verification engine 113. As depicted, the verification engine 113 can, in some embodiments, include a model verifier 221, models retriever 222, a translator 224, an equivalence theorem generator 226, a combiner 228, a constrained equivalence verifier 230, and a user interaction module 232. These components may be communicatively coupled via the bus 206 and/or the processor 202. In some embodiments, the model verifier 221, the models retriever 222, the translator 224, the equivalence theorem generator 226, the combiner 228, the constrained equivalence verifier 230, and the user interaction module 232 may be sets of instructions executable by the processor 202. In some embodiments, the model verifier 221, the models retriever 222, the translator 224, the equivalence theorem generator 226, the combiner 228, the constrained equivalence verifier 230, and the user interaction module 232 can be stored in the memory 204 of the computing device 200 and can be accessible and executable by the processor 202. The model verifier 221, the models retriever 222, the translator 224, the equivalence theorem generator 226, the combiner 228, the constrained equivalence verifier 230, and the user interaction module 232 may be adapted for cooperation and communication with the processor 202 and the other components of the computing device 200.

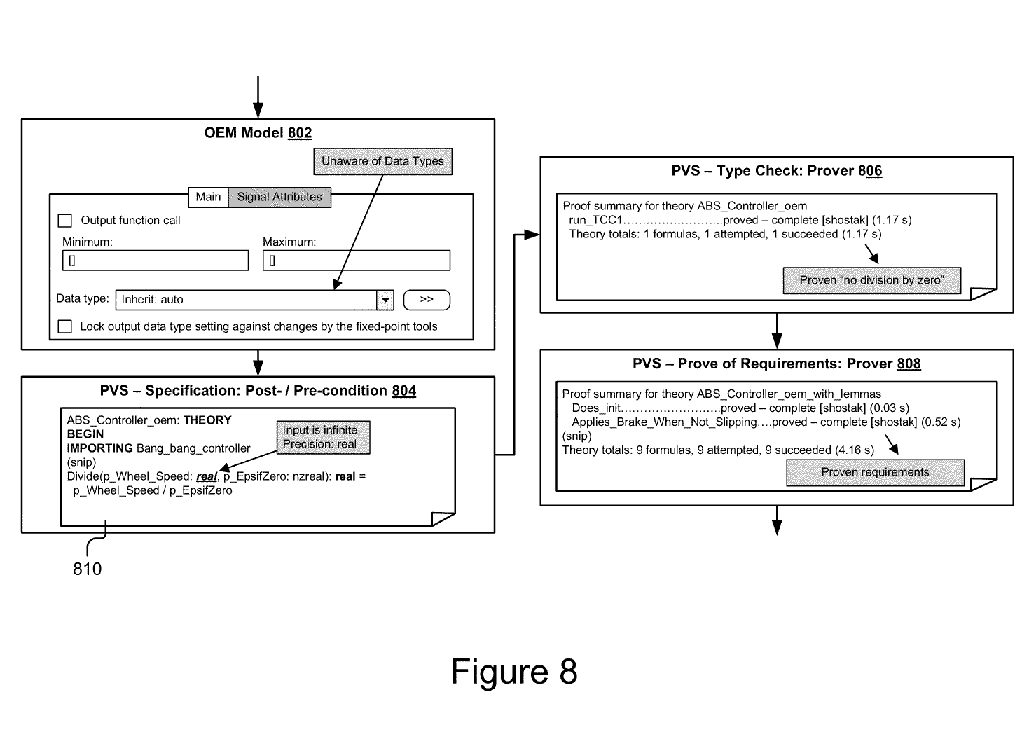

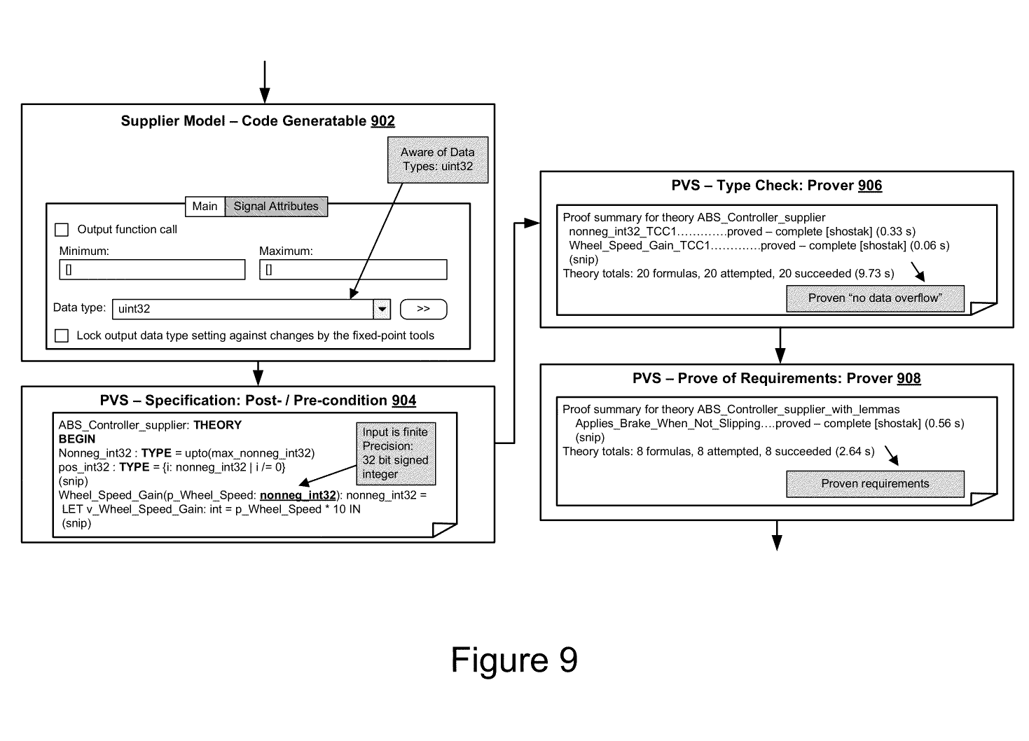

The model verifier 221 can include software and/or hardware logic for verifying compliance of a model with one or more software requirements. The model may be one of a development model (e.g., OEM model) or a production model (e.g., supplier model). A software requirement may be a specific condition that the model must satisfy in order to be considered compliant and/or effective with a particular standard. For example, a software requirement may be a “no division by zero” condition (e.g., as shown in FIG. 8) and the model should not raise any “division by zero” errors during its compilation in order to be considered compliant. By way of another example, a software requirement may be a “no data overflow” condition (e.g., as shown in FIG. 9) and the model should not raise any “data overflow” errors during its compilation in order to be considered compliant. Other examples of the software requirements may include, without limitation, a “no starvation” condition, a specific operation (procedure, function, method, etc.) that must be performed without leading to a failure state, specific variable and data types declarations, one or more rules satisfaction, etc.

In some embodiments, a model and a set of software requirements may be stored in a data store (e.g., the data store 210) and the model verifier 221 may access the data store to retrieve the model and the software requirements for verification. In some embodiments, each of the model and the software requirements may be required to be translated into a formal specification (e.g., PVS) before the model verifier 221 may perform its verification. The model verifier 221 may then send a signal to the translator 224 to translate each of the model and the software requirements into its respective specification. The translator 224 may perform its translation and send the formal specification for each back to the model verifier 221, as discussed elsewhere herein.

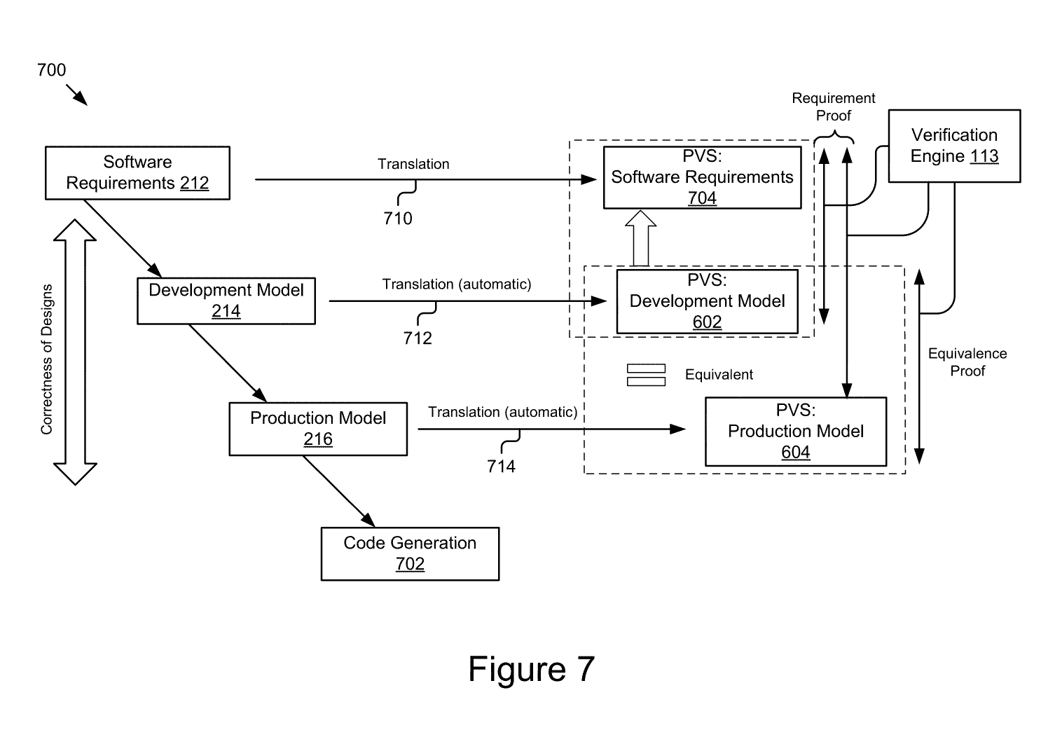

Responsive to receiving the formal specifications from the translator 224, the model verifier 221 may compare the formal specification of the model and the formal specification of the software requirements to determine whether the model complies with those requirements as shown, for example, in FIG. 7. In some embodiments, the formal specification of the software requirements may include a set of theories, where each theory corresponds to a software requirement, and the model verifier 221 may run the formal specification of the model with each theory to determine whether the model specification (including variable declarations, data types, loop conditions, switch cases, etc.) complies with the software requirement embodied by that theory. If the model is found to comply with all the software requirements, the model verifier 221 may determine the model as a verified model (e.g., compliant model) and store the verified model in a data store (e.g., verified model 217 in the data store 210). If on the other hand, the model is found to not comply with one or more requirements, then the model verifier 221 may determine the model as non-compliant.

In some embodiments, the model verifier 221 may generate a compliance summary describing software requirements that were satisfied and/or unsatisfied by a model. The model verifier 221 may store the compliance summary in a data store for later access and retrieval. For instance, the model verifier 221 may store the compliance summary as verification results 220 in the data store 220. In some embodiments, the model verifier 221 in cooperation with the user interaction module 224 may send the compliance summary for display to a user on the user device 135. Providing the compliance summary to the user is advantageous as the user may use the summary to identify one or more unsatisfied requirements and may modify the model in order for it to satisfy with those requirements and become compliant.

In some embodiments, a model verifier 221 can also verify a model including the development model or the production model based on one or more equivalence theorems (e.g., lemmas, proof-theories, predicates, type correctness conditions, etc.). An equivalence theorem, as discussed elsewhere herein, may be a condition that checks for a desired or intended output of a model for a particular scenario upon providing a specific input to the model. By way of example, consider the following two equivalence theorems:

```
Applies_Brake_When_At_Rest_Production: LEMMA
  FORALL (v_sys: ABS_Controller_production.sys_type):
  f_Apply_Brakes(f_output(ABS_Controller_production.run
        (v_sys, 0, 0))) = 1
Releases_Brake_When_At_Rest_Development: LEMMA
  FORALL (v_sys: ABS_Controller_development.sys_type):
      f_Apply_Brakes(f_output(ABS_Controller_development.run
        (v_sys, 0, 0))) = −1
```

The above two theorems state properties about when brakes will be applied by a vehicle. In each of these two theorems, the first zero in the parameter list corresponds to vehicle speed and the second zero corresponds to wheel speed. The first theorem shows that the production model applies the brake (e.g., since it has a return value of “1”) while the second theorem shows that the development model releases the brake (e.g., since it has a return value of “−1”). In essence, based on these theorems, the model verifier 221 has identified a flaw in the development model, because the vehicle's brakes should be applied when the car is at rest and the wheels are not turning.

The models retriever 222 can include software and/or hardware logic for retrieving a development model and a production model for constrained equivalence verification. In some embodiments, the models retriever 222 may perform its operation responsive to receiving a request from the constrained equivalence verifier 230. For example, the request may include that a development model and a production model be retrieved for constrained equivalence verification by the equivalence verifier 230 and responsive to receiving the request, the models retriever 222 may perform its retrieval. In some embodiments, the request may further include that only models that have been verified and/or determined as compliant with one or more software requirements be retrieved.

In some embodiments, the models retriever 222 may retrieve verified development and production models from the data store 210. For example, as discussed elsewhere herein, the model verifier 221 may determine a model, such as a development or a production model, as a verified model (e.g., model complying with one or more software requirements) and store the verified model in the data store 210. The models retriever 222 may access the data store 210 to retrieve a development model and a production model from the verified models 217 stored in the data store. In some embodiments, the models retriever 222 upon accessing the data store 210 may not find any verified models stored therein, the models retriever 222 may then retrieve a development model from the development models 214 and a production model from the production models 216 and send each of the retrieved models to the model verifier 221 for verification. Once each of the models are verified by the model verifier 221, the models retriever 222 may then pass those models to the constrained equivalence verifier 230 and/or the translator 224 for further processing.

The translator 224 can include software and/or hardware logic for translating each of a development model, a production model, and a set of software requirements into a formal specification. The formal specification may be a PVS specification language or a PVS theory, as discussed elsewhere herein. In some embodiments, the translator 224 may perform its operation responsive to receiving a request from the model verifier 221, the models retriever 222, and/or one or more other components of the verification engine 113. For instance, the request may include that a development model, a production model, and/or one or more software requirements be translated into a formal specification. Responsive to translating the models and/or the software requirements into formal specifications, the translator 224 may send these specifications to one or more components from which the translation request was received or to the equivalence theorem generator 226 for it to perform its acts and/or functionalities.

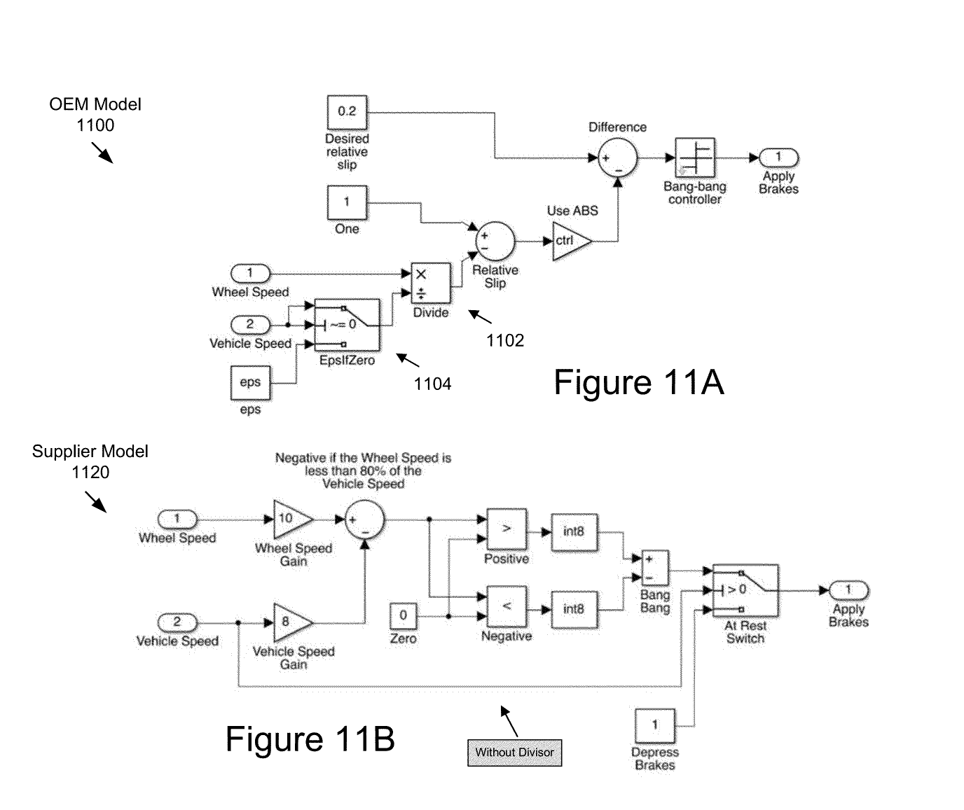

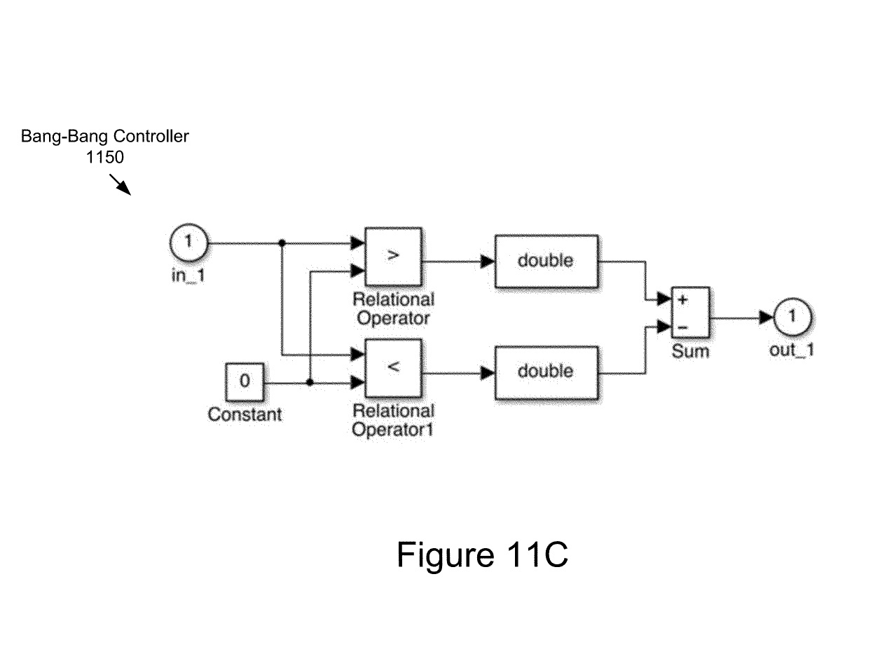

By way of example, below is a PVS specification generated by the translator 224 upon translating the OEM model 1100 depicted in FIG. 11A:

```
ABS_Controller_oem: THEORY
BEGIN
IMPORTING Bang_bang_controller
% Type of state
state_type: TYPE = [#
                    f_Bang_bang_controller_sys: Bang_bang_controller.sys_type
                  #]
% Type of output
out_type: TYPE = [#
                  f_Apply_Brakes: real
                #]
% Type of system state
sys_type: TYPE = [#
                  f_state: state_type,
                  f_output: out_type
                #]
Desired_relative_slip: real = 0.2
eps: real = (2 \hat{ } −52)
Use_ABS(p_Relative_Slip: real): real =
  LET v_Use_ABS: real = p_Relative_Slip * 1 IN
  v_Use_ABS
Apply_Brakes(p_Bang_bang_controller: real): real =
  p_Bang_bang_controller
EpsIfZero(p_Vehicle_Speed: real, p_Vehicle_Speed: real, p_eps: real): real =
  IF (p_Vehicle_Speed) /= 0 THEN
  p_Vehicle_Speed
  ELSE
  p_eps
  ENDIF
Difference(p_Desired_relative_slip: real, p_Use_ABS: real): real =
  LET v_Difference: real = p_Desired_relative_slip − p_Use_ABS IN
  v_Difference
Divide(p_Wheel_Speed: real, p_EpsIfZero: nzreal): real =
  p_Wheel_Speed / p_EpsIfZero
Relative_Slip(p_One: int, p_Divide: real): real =
  LET v_Relative_Slip: real = p_One − p_Divide IN
  v_Relative_Slip
One: int = 1
% Initialize state
prepare_state(p_Bang_bang_controller_sys:
Bang_bang_controller.sys_type): state_type =
  (#
  f_Bang_bang_controller_sys := p_Bang_bang_controller_sys
  #)
% Initialize output
prepare_output(p_Apply_Brakes: real): out_type =
  (#
  f_Apply_Brakes := p_Apply_Brakes
  #)
% Initialize system state
init: sys_type =
  (#
  f_state := prepare_state(Bang_bang_controller.init),
  f_output := prepare_output(0)
#)
% Whole system run, this can only be called after INIT and inputs setting
run(p_sys: sys_type, p_Vehicle_Speed: real, p_Wheel_Speed: real): sys_type =
  LET v_EpsIfZero: real = EpsIfZero(p_Vehicle_Speed, p_Vehicle_Speed, eps) IN
  LET v_Divide: real = Divide(p_Wheel_Speed, v_EpsIfZero) IN
  LET v_Relative_Slip: real = Relative_Slip(One, v_Divide) IN
  LET v_Use_ABS: real = Use_ABS(v_Relative_Slip) IN
  LET v_Difference: real = Difference(Desired_relative_slip, v_Use_ABS) IN
  LET v_Bang_bang_controller_sys: Bang_bang_controller.sys_type =
  Bang_bang_controller.run(p_sys\grave{ }f_state\grave{ }f_Bang_bang_controller_sys, v_Difference) IN
  LET v_Apply_Brakes: real = Apply_Brakes(v_Bang_bang_controller_sys\grave{ }f_output\grave{ }f_out_1_i2) IN
  (#
  f_state := prepare_state(v_Bang_bang_controller_sys),
  f_output := prepare_output(v_Apply_Brakes)
  #)
END ABS_Controller_oem
```

By way of another example, below is a PVS specification generated by the translator 224 upon translating the bang-bang controller 1150 depicted in FIG. 11C:

```
Bang_bang_controller: THEORY
BEGIN
% Type of output
out_type: TYPE = [#
                      f_out_1_i2: real
                  #]
% Type of system state
sys_type: TYPE = [#
                    f_output: out_type
                  #]
Sum(p_Data_Type_Conversion1: real, p_Data_Type_Conversion2: real): real =
  LET v_Sum: real = p_Data_Type_Conversion1 − p_Data_Type_Conversion2 IN
    v_Sum
Data_Type_Conversion1(p_Relational_Operator: bool): real =
  IF (p_Relational_Operator) THEN 1 ELSE 0 ENDIF
Relational_Operator(p_in_1_i1: real, p_Constant: int): bool =
  p_in_1_i1 > p_Constant
Relational_Operator1(p_in_1_i1: real, p_Constant: int): bool =
  p_in_1_i1 < p_Constant
Data_Type_Conversion2(p_Relational_Operator1: bool): real =
  IF (p_Relational_Operator1) THEN 1 ELSE 0 ENDIF
out_1_i2(p_Sum: real): real =
  p_Sum
Constant: int = 0
% Initialize output
prepare_output(p_out_1_i2: real): out_type =
  (#
    f_out_1_i2 := p_out_1_i2
  #)
% Initialize system state
init: sys_type =
  (#
    f_output := prepare_output(0)
  #)
% Whole system run, this can only be called after INIT and inputs setting
run(p_sys: sys_type, p_in_1_i1: real): sys_type =
  LET v_Relational_Operator: bool = Relational_Operator(p_in_1_i1, Constant) IN
  LET v_Relational_Operator1: bool = Relational_Operator1(p_in_1_i1, Constant) IN
  LET v_Data_Type_Conversion2: real = Data_Type_Conversion2(v_Relational_Operator1) IN
  LET v_Data_Type_Conversion1: real = Data_Type_Conversion1(v_Relational_Operator) IN
  LET v_Sum: real = Sum(v_Data_Type_Conversion1, v_Data_Type_Conversion2) IN
  LET v_out_1_i2: real = out_1_i2(v_Sum) IN
  (#
    f_output := prepare_output(v_out_1_i2)
  #)
END Bang_bang_controller
```

By way of yet another example, below is a PVS specification generated by the translator 224 upon translating the supplier model 1120 depicted in FIG. 11B:

```
ABS_Controller_supplier: THEORY
BEGIN
max_nonneg_int32 : int = 2\hat{ }32−1
nonneg_int32 : TYPE = upto(max_nonneg_int32)
pos_int32 : TYPE = {i: nonneg_int32 | i /= 0}
min_int32 : int = −2\hat{ }31
max_int32 : int = 2\hat{ }31−1
int32 : TYPE = {i: int | (min_int32 <= i) AND (i <= max_int32)}
nzint32 : TYPE = {i: int32 | i /= 0}
min_int16 : int = −2\hat{ }15
max_int16 : int = 2\hat{ }15−1
int16 : TYPE = {i: int | (min_int16 <= i) AND (i <= max_int16)}
nzint16 : TYPE = {i: int16 | i /= 0}
min_int8 : int = −2\hat{ }7
max_int8 : int = 2\hat{ }7−1
int8 : TYPE = {i: int | (min_int8 <= i) AND (i <= max_int8)}
nzint8 : TYPE = {i: int8 | i /= 0}
% Type of output
out_type: TYPE = [#
                    f_Apply_Brakes: int32
                  #]
% Type of system state
sys_type: TYPE = [#
                    f_output: out_type
                  #]
Wheel_Speed_Gain(p_Wheel_Speed: nonneg_int32): nonneg_int32 =
  LET v_Wheel_Speed_Gain: int = p_Wheel_Speed * 10 IN
  IF v_Wheel_Speed_Gain > max_nonneg_int32 THEN
    max_nonneg_int32
  ELSE
      IF v_Wheel_Speed_Gain < 0 THEN
        0
      ELSE
        v_Wheel_Speed_Gain
      ENDIF
  ENDIF
Apply_Brakes(p_At_Rest_Switch: int32): int32 =
  p_At_Rest_Switch
Vehicle_Speed_Gain(p_Vehicle_Speed: nonneg_int32): nonneg_int32 =
  LET v_Vehicle_Speed_Gain: int = p_Vehicle_Speed * 8 IN
  IF v_Vehicle_Speed_Gain > max_nonneg_int32 THEN
    max_nonneg_int32
  ELSE
      IF v_Vehicle_Speed_Gain < 0 THEN
        0
      ELSE
        v_Vehicle_Speed_Gain
      ENDIF
  ENDIF
At_Rest_Switch(p_Bang_Bang: int16, p_Vehicle_Speed: nonneg_int32, p_Depress_Brakes: int8): real =
  IF (p_Vehicle_Speed) > 0 THEN
    p_Bang_Bang
  ELSE
    p_Depress_Brakes
  ENDIF
Zero: int32 = 0
Negative(p_Sum: int32, p_Zero: int32): boot =
  p_Sum < p_Zero
Sum(p_Wheel_Speed_Gain: nonneg_int32, p_Vehicle_Speed_Gain: nonneg_int32): int32 =
  LET v_Sum: int = p_Wheel_Speed_Gain − p_Vehicle_Speed_Gain IN
  IF v_Sum > max_int32 THEN
    max_int32
  ELSE
      IF v_Sum < min_int32 THEN
        min_int32
      ELSE
        v_Sum
      ENDIF
  ENDIF
Bang_Bang(p_Data_Type_Conversion1: int8, p_Data_Type_Conversion2: int8): int16 =
  LET v_Bang_Bang: int = p_Data_Type_Conversion1 − p_Data_Type_Conversion2 IN
  IF v_Bang_Bang > max_int16 THEN
    max_int16
  ELSE
      IF v_Bang_Bang < min_int16 THEN
        min_int16
      ELSE
          v_Bang_Bang
      ENDIF
  ENDIF
Data_Type_Conversion1(p_Positive: bool): int8 =
  IF (p_Positive) THEN 1 ELSE 0 ENDIF
Data_Type_Conversion2(p_Negative: bool): int8 =
  IF (p_Negative) THEN 1 ELSE 0 ENDIF
Depress_Brakes: int8 = 1
Positive(p_Sum: int32, p_Zero: int32): bool =
  p_Sum > p_Zero
% Initialize output
prepare_output(p_Apply_Brakes: int32): out_type =
  (#
    f_Apply_Brakes := p_Apply_Brakes
  #)
% Initialize system state
init: sys_type =
  (#
    f_output := prepare_output(0)
  #)
% Whole system run, this can only be called after INIT and inputs setting
run(p_sys: sys_type, p_Vehicle_Speed: nonneg_int32, p_Wheel_Speed: nonneg_int32): sys_type =
  LET v_Wheel_Speed_Gain: real = Wheel_Speed_Gain(p_Wheel_Speed) IN
  LET v_Vehicle_Speed_Gain: real = Vehicle_Speed_Gain(p_Vehicle_Speed) IN
  LET v_Sum: int32 = Sum(v_Wheel_Speed_Gain, v_Vehicle_Speed_Gain) IN
  LET v_Positive: bool = Positive(v_Sum, Zero) IN
  LET v_Negative: bool = Negative(v_Sum, Zero) IN
  LET v_Data_Type_Conversion1: int8 = Data_Type_Conversion1(v_Positive) IN
  LET v_Data_Type_Conversion2: int8 = Data_Type_Conversion2(v_Negative) IN
  LET v_Bang_Bang: int16 = Bang_Bang(v_Data_Type_Conversion1, v_Data_Type_Conversion2) IN
  LET v_At_Rest_Switch: int32 = At_Rest_Switch(v_Bang_Bang, p_Vehicle_Speed, Depress_Brakes) IN
  LET v_Apply_Brakes: int32 = Apply_Brakes(v_At_Rest_Switch) IN
  (#
    f_output := prepare_output(v_Apply_Brakes)
  #)
END ABS_Controller_supplier
```

The equivalence theorem generator 226 can include software and/or hardware logic for generating one or more equivalence theorems for proofing constrained equivalence between a development model and a production model. An equivalence theorem may also be referred to interchangeably sometimes as a type correctness condition, a lemma, or a predicate. A type correctness condition, as discussed elsewhere herein, may be a condition that checks for whether the development model and the production model each produces an equivalent output within a specified tolerance for a particular scenario based on receiving one or more same inputs.

By way of example, consider the following first equivalence theorem:

```
Constrained_Equivalence: THEOREM
FORALL (v_sys: ABS_Controller_production.sys_type,
            vSpeed: {i: nonneg_int32 | i <= 100000},
            wSpeed: {i: nonneg_int32 | i <= 100000}):
f_Apply_Brakes(f_output(ABS_Controller_development.run
      (conv_sys(v_sys), vSpeed / 100, wSpeed / 100)))
            =
f_Apply_Brakes(f_output(ABS_Controller_production.run
      (v_sys, vSpeed, wSpeed)))
```

The above theorem states that the application of the brakes by the production model and the development model is equivalent for vehicle and wheel speeds with integer values in the range 0 to 100,000. The divisions by 100 in the development model are scale factors necessary to align the speed measurement units. Integer values are meaningful, because the data supplied by speed sensors are discrete. In order to prove the first equivalence theorem, one or more test cases or scenarios may be used. For example, the one or more scenarios may be 1) “apply brakes when car is moving and the wheels are not slipping”; 2) “apply brakes when the car is moving and the wheels are slipping”; and 3) “apply brakes when the car is at rest”, etc.

By way of another example, consider the following second equivalence theorem:

```
Constrained_Equivalence_When_Moving: THEOREM
    FORALL (v_sys: ABS_Controller_production.sys_type,
            vSpeed: {i: pos_int32 | i <= 100000},
            wSpeed: {i: nonneg_int32 | i <= 100000}):
f_Apply_Brakes(f_output(ABS_Controller_development.run
          (conv_sys(v_sys), vSpeed / 100, wSpeed / 100)))
              =
f_Apply_Brakes(f_output(ABS_Controller_production.run
        (v_sys, vSpeed, wSpeed)))
```

This theorem is the same as the first equivalence theorem, except that its inputs to the vehicle speed are only allowed to be positive integers, i.e., the case when the vehicle speed is zero is no longer considered.

In some embodiments, the equivalence theorem generator 226 may store the one or more equivalence theorems generated by it as proof-theorems 218 in the data store 210 for later access and/or retrieval by one or more components of the verification engine 113. In some embodiments, the equivalent theorem generator 226 may send the one or more generated equivalence theorems to the combiner 228 for it to perform its acts and/or functionalities.

The combiner 228 can include software and/or hardware logic for combining formal specifications of a development model and a production model and one or more equivalence theorems into a combined formal specification. In some embodiments, the combiner 228 may receive formal specification of each of the development model and the production model from the translator 224 and the one or more theorems from the equivalence theorem generator 226. In some embodiments, the combiner 228 may retrieve the formal specifications and the one or more theorems from a data store, such as the data store 210. Once the combiner 228 is done with preparing the combined formal specification, the combiner may send the combined specification to the constrained equivalence verifier 230, which may then use to verify constrained equivalence between the development model and the production model, as discussed elsewhere herein.

By way of example, below is a combined specification upon combining the formal specification of an OEM model with one or more equivalence theorems:

```
ABS_Controller_oem_with_lemmas: THEORY
  BEGIN
  IMPORTING ABS_Controller_oem, Bang_bang_controller
Does_Init: LEMMA
  LET v_Bang_bang_controller_sys: Bang_bang_controller.sys_type =
      f_Bang_bang_controller_sys(f_state(init)) IN
      (f_out_1_i2(f_output(v_Bang_bang_controller_sys)) = 0) AND
  (f_Apply_Brakes(f_output(init)) = 0)
Applies_Brake_When_Not_Slipping: LEMMA
  FORALL (v_sys: ABS_Controller_oem.sys_type,
          vSpeed: {v: nzreal | v >= (2 \hat{ } −52)},
          wSpeed: {w: real | w > 0.8 * vSpeed }):
    f_Apply_Brakes(f_output(run(v_sys, vSpeed, wSpeed))) = 1
Lets_Off_Brake_When_Slipping: LEMMA
  FORALL (v_sys: ABS_Controller_oem.sys_type,
            vSpeed: {v: nzreal | v >= (2 \hat{ } −52)},
            wSpeed: {w: real | w < 0.8 * vSpeed }):
    f_Apply_Brakes(f_output(run(v_sys, vSpeed, wSpeed))) = −1
Does_Neither_At_Threshold: LEMMA
  FORALL (v_sys: ABS_Controller_oem.sys_type,
            vSpeed: {v: nzreal | v >= (2 \hat{ } −52)}):
    f_Apply_Brakes(f_output(run(v_sys, vSpeed, 0.8 * vSpeed))) = 0
% Question from Supplier: is this really the desired behavior?
Releases_Brake_When_At_Rest_And_Wheels_Stopped: LEMMA
  FORALL (v_sys: ABS_Controller_oem.sys_type):
    f_Apply_Brakes(f_output(run(v_sys, 0, 0))) = −1
% Helper lemmas
Divide_Is_GTE_1_When_At_Rest_And_Wheels_Turning: LEMMA
  FORALL (p_Wheel_Speed: {w: real | w > 2 \hat{ } −52}):
    LET p_Vehicle_Speed = 0 IN
    % First two lines from run
    LET v_EpsIfZero: real = EpsIfZero(p_Vehicle_Speed, p_Vehicle_Speed, eps) IN
    LET v_Divide: real = Divide(p_Wheel_Speed, v_EpsIfZero) IN
    v_Divide >= 1
Relative_Slip_Is_LTE_0_When_At_Rest_And_Wheels_Turning: LEMMA
  FORALL (p_Wheel_Speed: {w: real | w > 2 \hat{ } −52}):
    LET p_Vehicle_Speed = 0 IN
    % First two lines from run
    LET v_EpsIfZero: real = EpsIfZero(p_Vehicle_Speed, p_Vehicle_Speed, eps) IN
    LET v_Divide: real = Divide(p_Wheel_Speed, v_EpsIfZero) IN
    LET v_Relative_Slip: real = Relative_Slip(One, v_Divide) IN
    v_Relative_Slip <= 0
Applies_Brake_When_At_Rest_And_Wheels_Turning: LEMMA
  FORALL (v_sys: ABS_Controller_oem.sys_type,
            wSpeed: {w: real | w > 2 \hat{ } −52}):
    f_Apply_Brakes(f_output(run(v_sys, 0, wSpeed))) = 1
END ABS_Controller_oem_with_lemmas
```

In some embodiments, the above combined specification may be used by the model verifier 221 and/or the constrained equivalence verifier 230 for verifying compliance or accuracy of the OEM model (e.g., development model). For example, the model verifier 221 or the constrained equivalence verifier 230 may compile the above specification and determine that for case “when vehicle is at rest and the wheels are not rotating”, the OEM model releases the brakes, which is not right. This way any inconsistencies associated with the OEM model may be determined and notified to a user associated with the OEM model for taking correctives measures.

By way of another example, below is a combined specification upon combining the formal specification of a supplier model with one or more equivalence theorems:

```
ABS_Controller_supplier_with_lemmas: THEORY
  BEGIN
  IMPORTING ABS_Controller_supplier
Does_Init: LEMMA
  f_Apply_Brakes(f_output(init)) = 0
Applies_Brake_When_Not_Slipping: LEMMA
  FORALL (v_sys: sys_type,
            vSpeed: {v: pos_int32 | v <= 100000},
            wSpeed: {w: nonneg_int32 | w > 0.8 * vSpeed
            AND w <= 100000}):
    f_Apply_Brakes(f_output(run(v_sys, vSpeed, wSpeed))) = 1
Lets_Off_Brake_When_Slipping: LEMMA
  FORALL (v_sys: sys_type,
            vSpeed: {v: pos_int32 | v <= 100000},
            wSpeed: {w: nonneg_int32 | w < 0.8 * vSpeed }):
    f_Apply_Brakes(f_output(run(v_sys, vSpeed, wSpeed))) = −1
Does_Neither_At_Threshold: LEMMA
  FORALL (v_sys: sys_type,
            vSpeed: {v: pos_int32 | v <= 100000},
            wSpeed: {w: nonneg_int32 | w = 0.8 * vSpeed }):
    f_Apply_Brakes(f_output(run(v_sys, vSpeed, 0.8 * vSpeed))) = 0
% Note that this differs from OEM behavior
Applies_Brake_When_At_Rest_And_Wheels_Stopped: LEMMA
  FORALL (v_sys: sys_type):
    f_Apply_Brakes(f_output(run(v_sys, 0, 0))) = 1
Applies_Brake_When_At_Rest_And_Wheels_Turning: LEMMA
  FORALL (v_sys: sys_type,
            wSpeed: {w: pos_int32 | w <= 100000}):
    f_Apply_Brakes(f_output(run(v_sys, 0, wSpeed))) = 1
END ABS_Controller_supplier_with_lemmas
```

As stated earlier, the above combined specification may be used by the model verifier 221 and/or the constrained equivalence verifier 230 for verifying compliance or accuracy of the supplier model (e.g., production model). For example, the model verifier 221 or the constrained equivalence verifier 230 may compile the above specification and determine that for case “when vehicle is at rest and the wheels are not rotating”, the supplier model applies the brakes, which is in fact correct.

By way of yet another example, below is a combined specification upon combining the formal specification of the OEM model, the formal specification of the supplier model and a set of theorems:

```
ABS_Controller_equiv: THEORY
BEGIN
IMPORTING ABS_Controller_oem
IMPORTING ABS_Controller_supplier
IMPORTING ABS_Controller_oem_with_lemmas
IMPORTING ABS_Controller_supplier_with_lemmas
conv_sys(in_sys: ABS_Controller_supplier.sys_type): ABS_Controller_oem.sys_type =
(#
    f_state := ABS_Controller_oem.prepare_state(Bang_bang_controller.init),
    f_output := ABS_Controller_oem.prepare_output(f_Apply_Brakes(f_output(in_sys)))
  #)
% Helper lemmas
same_run_when_not_slipping: LEMMA
  FORALL (v_sys: ABS_Controller_supplier.sys_type,
            vSpeed: {v: pos_int32 | v <= 100000},
            wSpeed: {w: nonneg_int32 | w > 0.8 * vSpeed AND w <= 100000}):
    f_Apply_Brakes(f_output(ABS_Controller_oem.run(conv_sys(v_sys), vSpeed / 100, wSpeed / 100))) =
      f_Apply_Brakes(f_output(ABS_Controller_supplier.run(v_sys, vSpeed, wSpeed)))
same_run_when_slipping: LEMMA
  FORALL (v_sys: ABS_Controller_supplier.sys_type,
            vSpeed: {v: pos_int32 | v <= 100000},
            wSpeed: {w: nonneg_int32 | w < 0.8 * vSpeed }):
    f_Apply_Brakes(f_output(ABS_Controller_oem.run(conv_sys(v_sys), vSpeed / 100, wSpeed / 100))) =
      f_Apply_Brakes(f_output(ABS_Controller_supplier.run(v_sys, vSpeed, wSpeed)))
same_run_at_threshold: LEMMA
  FORALL (v_sys: ABS_Controller_supplier.sys_type,
            vSpeed: {v: pos_int32 | v <= 100000},
            wSpeed: {w: nonneg_int32 | w = 0.8 * vSpeed }):
    f_Apply_Brakes(f_output(ABS_Controller_oem.run(conv_sys(v_sys), vSpeed / 100, wSpeed / 100))) =
      f_Apply_Brakes(f_output(ABS_Controller_supplier.run(v_sys, vSpeed, wSpeed)))
same_run: LEMMA
  FORALL (v_sys: ABS_Controller_supplier.sys_type,
            vSpeed: {i: pos_int32 | i <= 100000},
            wSpeed: {i: nonneg_int32 | i <= 100000}):
    f_Apply_Brakes(f_output(ABS_Controller_oem.run(conv_sys(v_sys), vSpeed / 100, wSpeed / 100))) =
      f_Apply_Brakes(f_output(ABS_Controller_supplier.run(v_sys, vSpeed, wSpeed)))
END ABS_Controller_equiv
```

In the above combined specification, the last lemma (e.g., equivalence theorem, type correctness condition, etc.) same run, states that for all positive integer vehicle speeds up to 100000 (which corresponds to 1000.00 rad/s) and for all non-negative wheel speeds up to 100000 (also corresponding to 1000.00 rad/s), the results of the two models (the OEM model and the supplier model) are identical. Upon verifying the above specification by the constrained equivalence verifier 230, the below proof summary may be generated:

```
Proof summary for theory ABS_Controller_equiv
  same_run_when_not_slipping............proved - complete
  [shostak](2.83 s)
  same_run_when_slipping................proved - complete
  [shostak](2.29 s)
  same_run_at_threshold.................proved - complete [shostak](2.22 s)
  same_run..............................proved - complete [shostak](0.07 s)
  Theory totals: 4 formulas, 4 attempted, 4 succeeded (7.41 s)
```

The constrained equivalence verifier 230 can include software and/or hardware logic for verifying constrained equivalence between a development model and a production model. The constrained equivalent verifier 230 may perform this verification based on the combined specification generated by the combiner 228, as discussed elsewhere herein. In some embodiments, the constrained equivalence verifier may be communicatively coupled to the combiner 228 to receive the combined specification and then perform its verification.

In some embodiments, as discussed elsewhere herein, the constrained equivalence verifier 230 may verify constrained equivalence for two models based on whether the two models satisfy an equivalence condition associated with each of a set of equivalence theorems. In particular, for each equivalence theorem, the constrained equivalence verifier 230 tests for whether 1) for all valid inputs, a production model (e.g., supplier model) produces a result equivalent to a result produced by the development model (e.g., OEM model), within a specified delta and 2) for all valid inputs to the production model, there exist inputs to the development model within a specified deltas of the inputs to the production model such that the results of both models are equal.

In some embodiments, the constrained equivalence verifier 230 may require user guidance for completing a constrained equivalence proof for an equivalence theorem. For example, for an equivalence theorem, the constrained equivalence verifier 230 may not be able to automatically determine or be 100% certain of whether a development model is constrained equivalent to a production model. In such a scenario, the constrained equivalence verifier 230 may send a signal to the user interaction module 232 to request the user for guidance in constrained equivalence verification. Responsive to receiving the user guidance, the constrained equivalence verifier 230 may be able to complete the equivalence proof for the equivalence theorem. In another example, the constrained equivalence verifier 230 may require user guidance to decide which proof strategies the verifier 230 should attempt in case it is not able to complete the proof using its automated procedure.

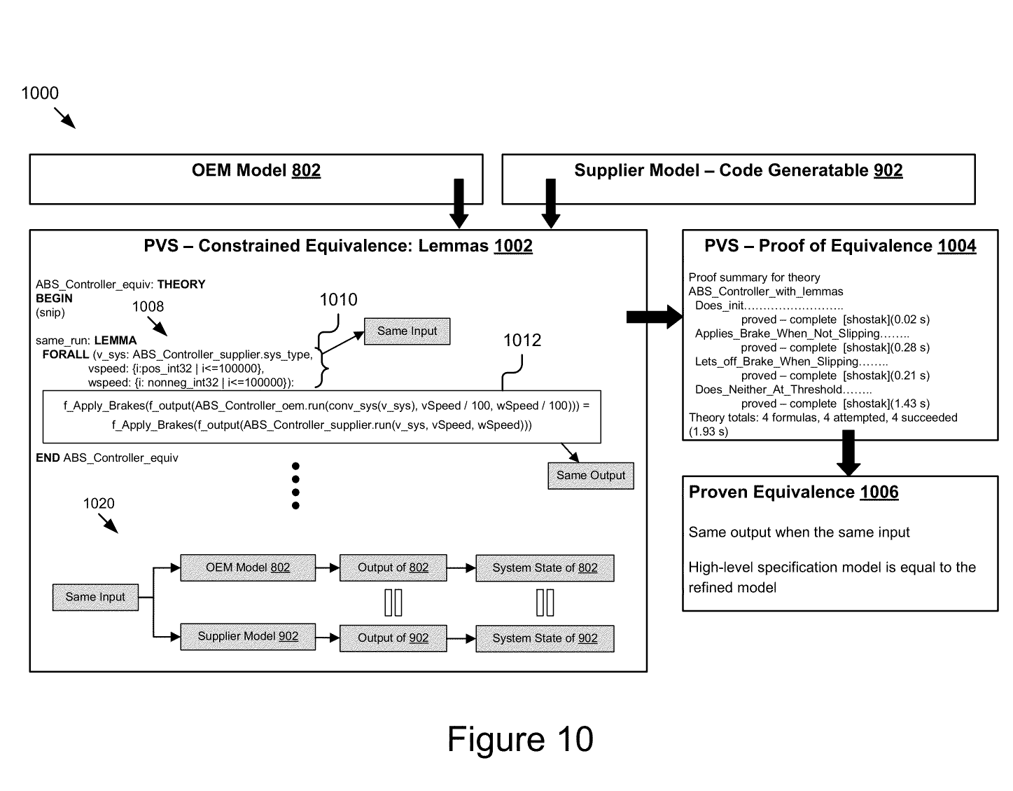

In some embodiments, responsive to testing each equivalence theorem, the constrained equivalence verifier 230 may generate a test or a proof summary describing for each theorem whether constrained equivalence between models was satisfied or un-satisfied, as depicted for example in proof summary 1004 in FIG. 10. In some embodiments, the constrained equivalent verifier 230 may store the proof summary as verification results 220 in the data store 210. In some embodiments, the constrained equivalence verifier 230 may signal the user interaction module 232 to present the proof summary to a user on the user device 135.

The user interaction module 232 can include software and/or hardware logic for interacting with a user for one or more responses and for providing verification results to the user for display. For instance, a response may include a user guidance related to a constrained equivalence verification requested by the constrained equivalence verifier 230 for an equivalence theorem, as discussed elsewhere herein. For instance, verifications results may include a proof summary describing for each theorem whether the theorem was satisfied/un-satisfied for constrained equivalence, a compliance summary describing for each software requirement from a set of software requirements whether the requirement was satisfied/un-satisfied by a model (e.g., development, production, etc.), a constrained equivalence status describing whether a development model determined to be constrained equivalent to a production model or not, and a model compliance status describing whether a model complies with a set of software requirements or not, etc.

### Methods

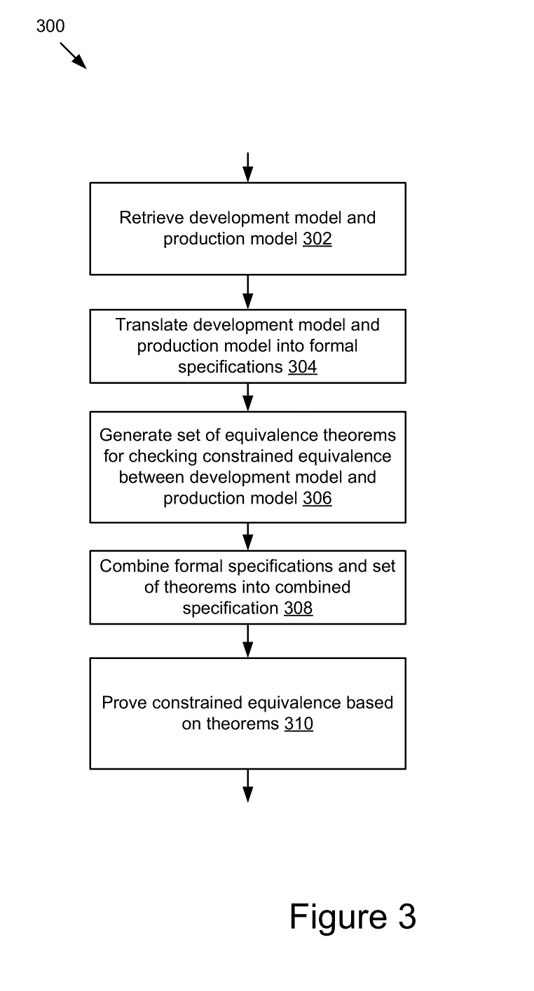

FIG. 3 is a flowchart of an example method 300 for verifying constrained equivalence between a development model 214 and a production model 216. The models retriever 222 may retrieve 302 the development model 214 and the production model 216. In some embodiments, prior to retrieving the development model 214 and the production model 216, each of the models may be verified with a set of software requirements to determine the model compliance with those requirements. Responsive to verifying each of the models compliance, the method 300 may then begin its operations at block 302. In some embodiments, verification of the models may be performed by the model verifier 221.

Once the models are retrieved, the translator 224 may translate 304 each of the development model 214 and the production model 216 into a formal specification. In some embodiments, the formal specification may be a prototype verification system (PVS) specification language that includes a set of theories, as discussed elsewhere herein. The equivalence theorem generator 226 may then generate 306 a set of equivalence theorems for checking constrained equivalence between the development model 214 and the production model 216. An equivalence theorem may be a condition that checks for whether the development model 214 and the production model 216 each produces a same or an equivalent output that is within a first specified tolerance for a particular scenario responsive to receiving one or more same inputs or equivalent inputs that are within a second specified tolerance. In some instances, the equivalence theorem may also be sometimes referred to interchangeably as a lemma, theorem type correctness condition, or a predicate throughout this disclosure.

The combiner 226 may then combine 308 the formal specifications of the development model 214 and the production model 216 (translated in block 304) and the set of theorems into a combined formal specification. For instance, the combined specification may include the formal specification of the development model 214, the formal specification of the production model 216, and the set of equivalence theorems into a single file or document. The constrained equivalence verifier 230 may then prove 310 constrained equivalence for the development model 214 and the production model 216 based on the theorems. In some embodiments, the constrained equivalence verifier 230 may prove the constrained equivalence based on each of the theorems being proven, as explained in further detail elsewhere herein.

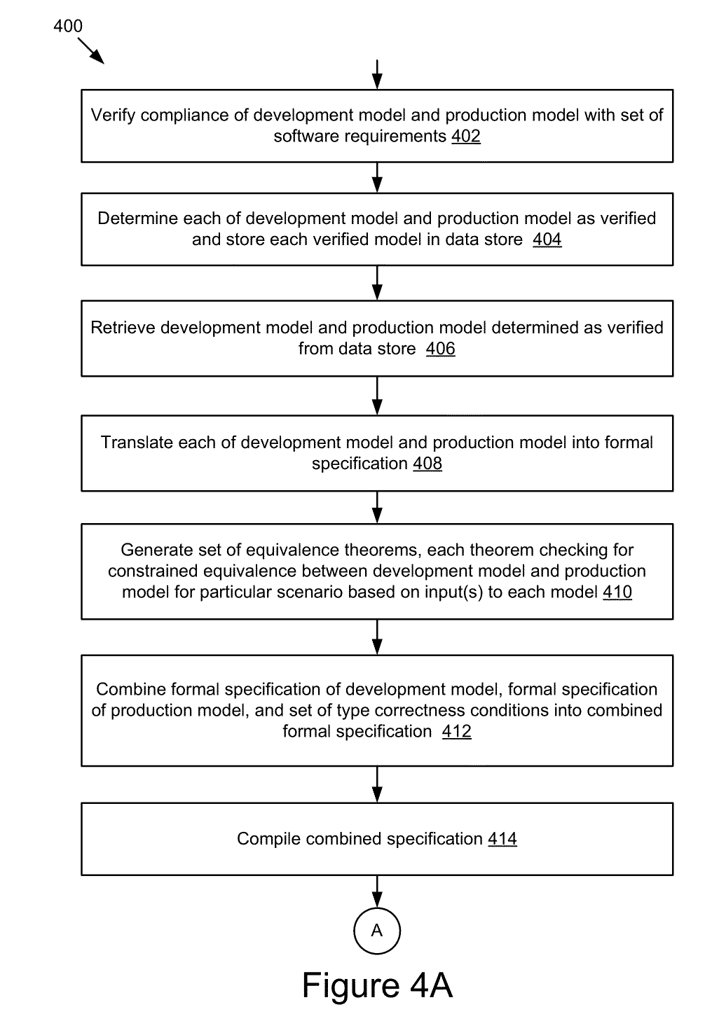

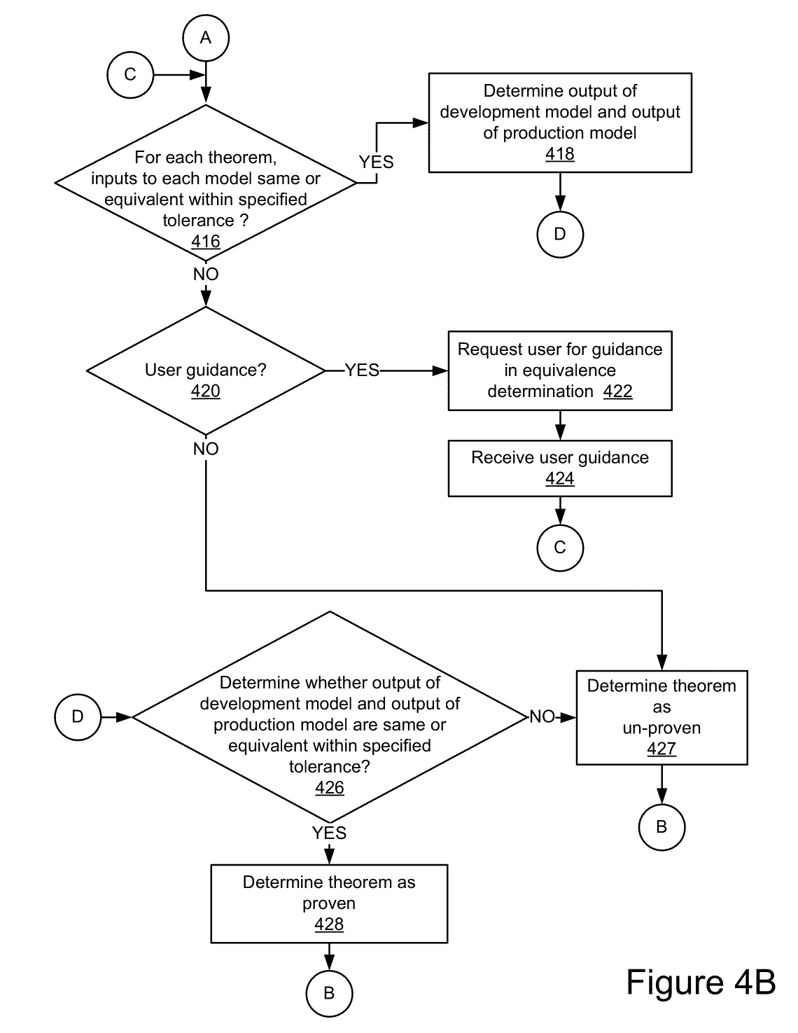

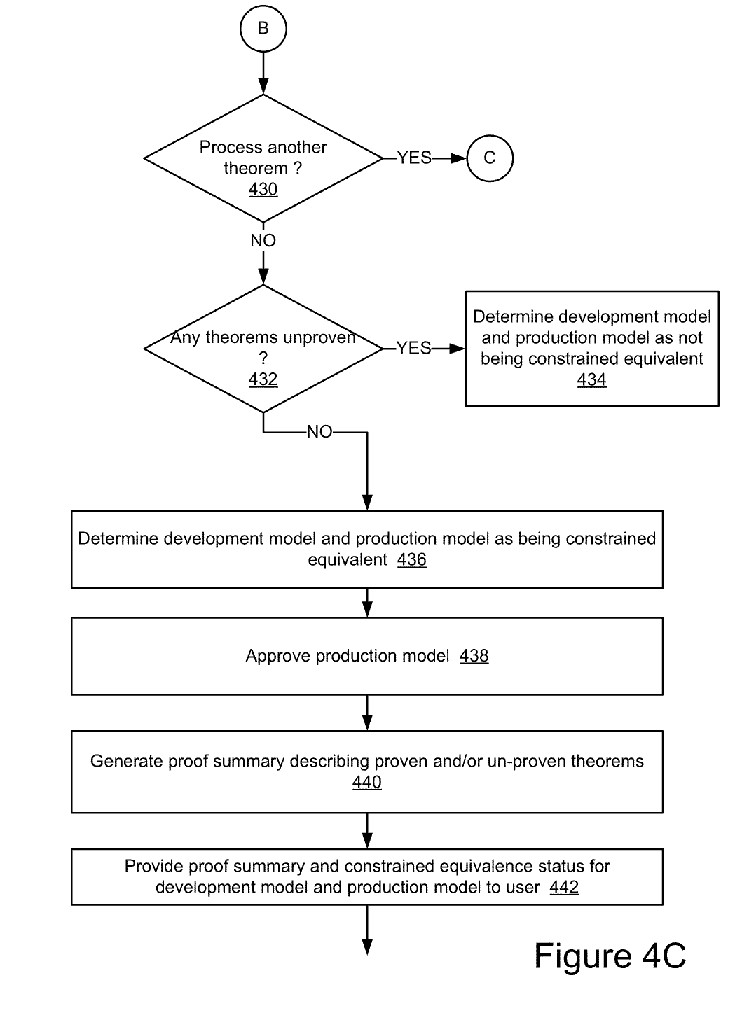

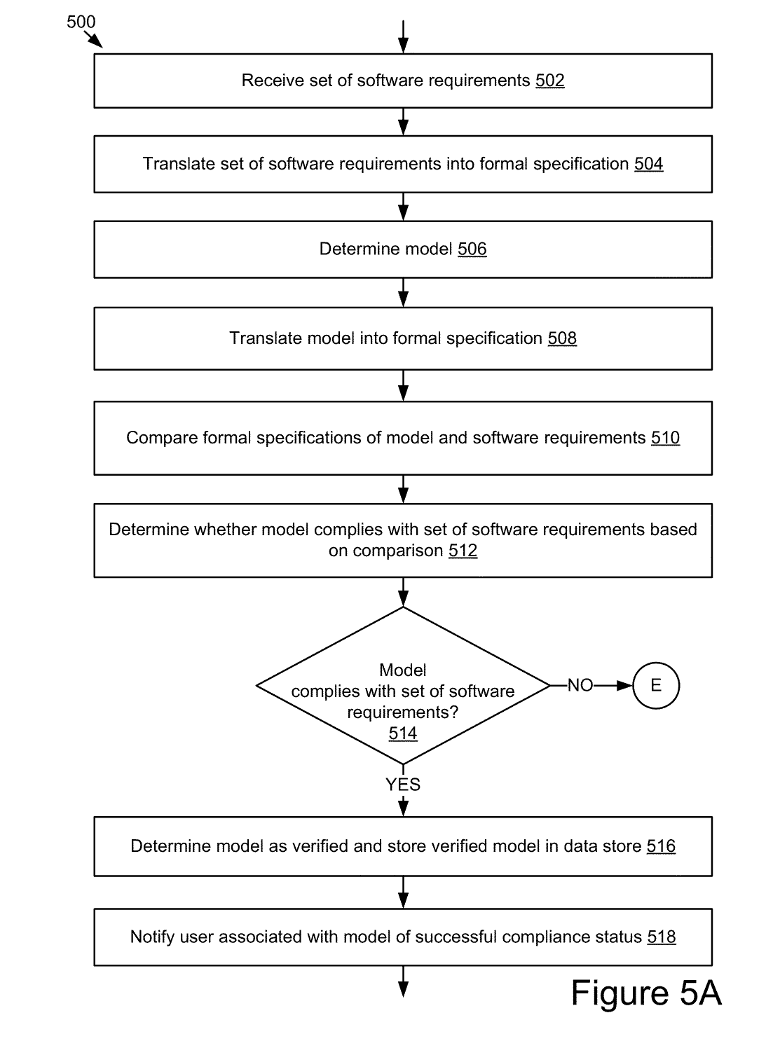

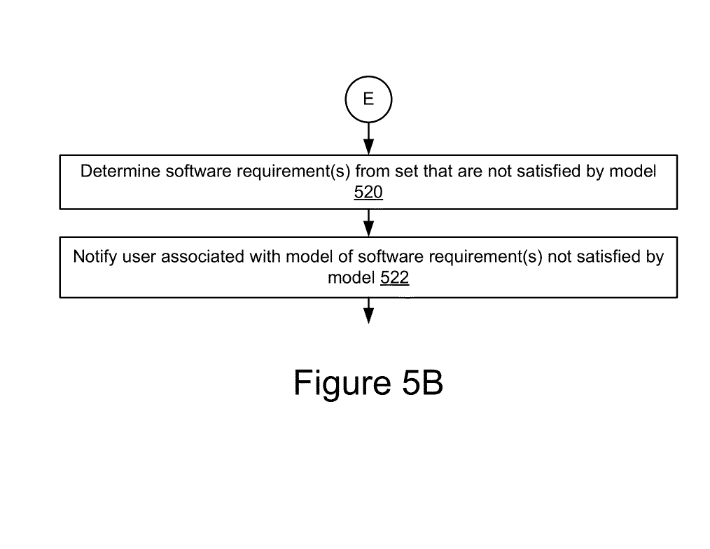

FIGS. 4A-4C are flowcharts of an example method 400 for verifying constrained equivalence between a development model and a production model. Referring to FIG. 4A, the model verifier 221 may verify 402 compliance of each of a development model and a production model with a set of software requirements. Responsive to verifying the compliance for each of the models, the model verifier 221 may determine 404 each model as a verified model and store the verified model in a data store, such as verified model 217 in the data store 210. Detailed description regarding operations 402 and 404 are described below with respect to FIGS. 5A and 5B and will not be repeated here.

The models retriever 222 may then access the data store (e.g., data store 210) and retrieve 406 the development model and the production model that were determined as verified in block 404 from the data store. The models retriever 222 may send the retrieved models to the translator 224, which may then translate 408 each of the models into a formal specification. By way of visual illustration, the translator 224 may translate a development model, such as OEM model 802 into a formal specification, such as PVS 804 as shown in FIG. 8. By way of another visual illustration, the translator 224 may translate a production model, such as supplier model 902 into a formal specification, such as PVS 904 as shown in FIG. 9.

The equivalence theorem generator 226 may generate 410 a set of equivalence theorems (e.g., lemmas, predicates, proof-theorems, type correctness conditions, etc.). In some instances, each of the theorems tests for constrained equivalence between the development model and the production model for a particular scenario based on providing one or more same inputs or equivalent inputs that are within a specified tolerance to these models. By way of example, the equivalence theorem 1008 in FIG. 10 declares one or more same inputs 1010 and checks in block 1012 whether each of the OEM model (e.g., development model) and the supplier model (e.g., production model) applies brakes on receiving the one or more same inputs 1010. In this example, “apply brakes” is the particular scenario, which the theorem 1008 checks for the OEM model and the supplier model constrained equivalence.

The combiner 228 may then combine 412 the formal specification of the development model, the formal specification of the production model, and the equivalence theorems into a combined formal specification. For example, the combiner 228 may form a combined PVS 1002 as shown in FIG. 10. The constrained equivalence verifier 230 may then compile 414 the combined specification. Referring now to FIG. 4B, once the combined specification is compiled, the constrained equivalence verifier 230 may determine 416 for each theorem, whether one or more inputs to each model are the same or within a first specified tolerance. If the result of the determination in block 416 is affirmative, then the constrained equivalence verifier 230 may determine 418 an output of the development model and an output of the production model based on the one or more inputs determined in block 416. Once the output for each model is determined, the constrained equivalence verifier 230 may determine in block 426 whether the output of the development model and the output of the production model are the same or equivalent within a second specified tolerance. If the result in block 426 is affirmative, the constrained equivalent verifier 230 may determine 428 the theorem processed in block 416 as proven. Otherwise, the constrained equivalence verifier 230 may determine 427 the theorem as un-proven.

If on the other hand, the result of the determination in block 416 is negative, the constrained equivalence verifier 230 may determine in block 420 whether any user guidance is required for the determination in block 416. If the result of the determination in block 420 is affirmative, the constrained equivalent verifier 230 may signal the user interaction module 232 to request 422 a user provide guidance in equivalence determination. The user interaction module 232 may receive 424 necessary user guidance and send the guidance to the constrained equivalence verifier 230. The constrained equivalence verifier 230 may then resume its operation at block 416 and complete the determination.

Referring now to FIG. 4C, the constrained equivalence verifier 230 may determine in block 430 whether to process another theorem. If yes, the verifier 230 may return to block 416 to process the next theorem. Otherwise, the verifier 230 may proceed to block 432 to determine whether any of the theorems that were processed by the verifier 230 were determined as un-satisfied. If the result of the determination in block 432 is affirmative, then the constrained equivalence verifier 230 may determine 434 the development model and the production model as not being constrained equivalent to each other. Otherwise, the constrained equivalence verifier 230 may determine 436 the models as constrained equivalent to each other.

Responsive to determining both the models as equivalent in block 436, the constrained equivalence verifier 230 may further approve 438 the production model. In some embodiments, approving a production model means that the one or more modifications, which are performed by a user (e.g., supplier, producer, etc.) to the development model (e.g., OEM model) according to his/her software or hardware needs, satisfy a particular standard and does not violate the original development model implementation adversely. The constrained equivalence verifier 230 may generate 440 a proof summary describing proven and/or un-proven theorems (e.g., proof of equivalence summary 1004 shown in FIG. 10) and may provide 442, in cooperation with the user interaction module 232, the proof summary and a constrained equivalence status for the development model and the production model (e.g., whether models were determined as equivalent/not-equivalent) to a user. In some embodiments, the user may be a developer associated with the development model, a supplier associated with the production model, or a supervisor supervising both the models.

FIGS. 5A and 5B are flowcharts of an example method 500 for verifying compliance of a model with a set of software requirements. In some embodiments, the method 500 is a representation of a general method that may be applied to either a development model or a production model for checking its compliance with the set of software requirements. For example, in a development instance, the method 500 may verify compliance of a development model 214 with the set of software requirements. In a production instance, the method 500 may verify compliance of a production model 216 with the set of software requirements. The operations 502-522 are described below to be performed by the model verifier 221. However, it should be understood that these operations can also by performed by the development application 103 or the production application 109. For example, in the development instance, the operations 502-522 may be performed by the development application 103 and in the production instance, these operations may be performed by the production application 109.

Referring now to FIG. 5A, the model verifier 221 may receive a set of software requirements 502. The software requirements may include one or more conditions, rules, and/or requirements that a model (e.g., development, production, etc.) should satisfy in order to be considered compliant. By way of example, a software requirement may be that a model should not contain any “division by zero” instances. In some embodiments, the model verifier 221 may receive the set of software requirements from a data store, such as the data store 210. The translator 224 may then translate 504 the set of software requirements into a formal specification. The formal specification may include the software requirements into a set of verifiable or provable theories.

The model verifier 221 may then determine 506 a model for compliance verification. For instance, the model verifier 221 may determine in block 506 whether the model to be verified is a development model or a production model. In some embodiments, the model verifier 221 may make this determination in cooperation with the development application 103. For instance, a user (e.g., a developer) associated with a development model may make a request using the development application 103 that his/her model be verified and the development application 103 may forward the request to the model verifier 221 for development model verification. In some embodiments, the model verifier 221 may make the determination in cooperation with the production application 109. For instance, a user (e.g., a producer, supplier, etc.) associated with a production model may make a request using the production application 109 that his/her model be verified and the production application 109 may forward the request to the model verifier 221 for production model verification. Other variations are also possible and contemplated.

Once the model is determined, the model verifier 221 may then signal the translator 224 to translate 508 the model into a formal specification. The formal specification may include the model design implementation into a set of verifiable or provable theories, as depicted for example by reference numerals 804 and 904 in FIGS. 8 and 9, respectively. The model verifier 221 may then compare 510 formal specifications of each of the model and the software requirements with one another and determine 512 whether the model complies with the set of software requirements. If in block 514, the model verifier 221 determines the model to comply with the set of software requirements, the model verifier 221 may determine the model as verified and store the model as a verified model in a data store, such as verified model 217 in the data store 210. If on the other hand, the model verifier 221 determines the model to be not complying with the software requirements, the model verifier 221 may determine 520 (see FIG. 5B) one or more software requirements from the set that the model fails to comply with. The model verifier 221 may further notify 522 a user associated with the model (e.g., manufacturer, developer, supplier, etc.) of the one or more software requirements that were not satisfied by the model. Notifying the user of the non-satisfied software requirements is advantageous as the user may be able to take necessary actions or make modifications to the model in order to make the model compliable.

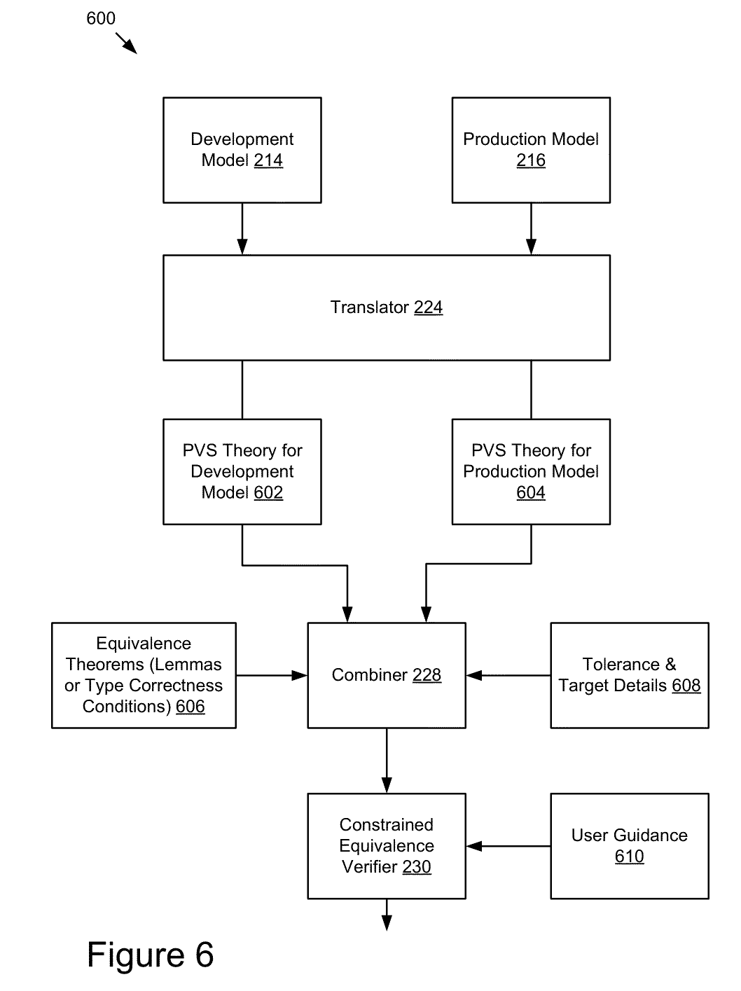

FIG. 6 is a diagram illustrating an example method 600 for performing constrained equivalence of a development model 214 and a production model 216. As depicted, the method 600 begins by the translator 224 receiving the development model 214 and the production model 216. In some embodiments, the models retriever 222 retrieves the development model and the production model, each verified and stored by the model verifier 221, from the data store 210 and send those models to the translator 224 for translation. The translator 224 may then translate the development model 214 into a PVS theory 602 and translate the production model 216 into a PVS theory 604. By way of illustration, the translator 224 may translate OEM model 802 (e.g., development model) into the PVS-specification 804 as shown in FIG. 8 and may translate supplier model 902 (e.g., production model) into the PVS-specification 904 as shown in FIG. 9. Once each of the models are translated, the translator 224 may send the PVS theory associated with each of the models to the combiner 228 for it to perform its acts and/or functionalities as discussed below.

The combiner 228 may receive the PVS theory 602 associated with the development model 214, the PVS theory 604 associated with the production model 216, one or more equivalence theorems 606, and tolerance and target details 608, and may combine each one of these into a combined formal specification (not shown). The tolerance and target details 608 may include details regarding desired tolerance limits or threshold upto which a development model and a production model may be considered equivalent. The tolerance and target details 608 may also include target requirements that the development model and the production model must satisfy in order to be considered equivalent.

Once 602, 604, 606, and 608 are combined by the combiner 228 into the combined specification, the combiner 228 may send the combined specification to the constrained equivalence verifier 230 for verifying constrained equivalence between the development model 214 and the production model 216, as discussed elsewhere herein. In some embodiments, during the constrained equivalence verification of the development and the production model, the constrained equivalence verifier 230 may encounter a situation where verification is not 100% achieved and user guidance is required in order to guarantee that verification. In such a scenario, the constrained equivalence verifier 230 in cooperation with the user interaction module 232 may request the user to provide the necessary user guidance 610. Responsive to receiving the necessary user guidance 610, the constrained equivalence verifier 230 may complete the constrained equivalence verification for the development model 214 and the production model 216.

FIG. 7 is a diagram illustrating an example method 700 for performing software requirements proof and constrained equivalence proof of a development model 214 and a production model 216. The software requirements proof may be a proof for a model's compliance (e.g., development model compliance, production model compliance, etc.) with the software requirements 212. The constrained equivalence proof may be a proof for showing that the development model 214 and the production model 216 are constrained equivalent to each other. The method 700 may begin by translating the software requirements into a formal specification, such as PVS: software requirements 704, as indicated by signal line 710. The development model 214 and the production model 216 may also be each translated into a formal specification 602 and 604, as indicated by signal lines 712 and 714, respectively. In some embodiments, the translations as indicated by the signal lines 710, 712, and 714 may be performed by the translator 224 of the verification engine 113.

Once each of the software requirements 212, the development model 214, and the production model 216 are translated into their respective specifications (e.g., PVS), the verification engine 113 may then check for the requirement proof and the equivalence proof. In some embodiments, a requirement proof for each of the models may be required to be performed prior to performing an equivalence proof. Doing the requirement proof for the models prior to their equivalence proof is advantageous as any faults or errors associated these models may be corrected in advance prior to doing their equivalence test, which may further save time, cost, and leads to more efficient and sound results. In some embodiments, for doing the requirement proof, the verification engine 113 may compare the PVS: software requirements 704 with each of the PVS: development model 602 and the PVS: production model 604 to determine whether each of the development model 214 and the production model 216 complies with the software requirements 212. For the equivalence proof, the verification engine 113 may determine whether the PVS: development model 602 is equivalent to the PVS: production model 604 within a specified tolerance limit, as discussed elsewhere herein. In some embodiments, responsive to achieving the equivalence proof for the two models, the verification engine 113 may approve the production model 216 and may further proceed for code generation 702.

FIG. 8 illustrates an example method 800 for verifying an example OEM model 802 with one or more software requirements. As depicted, the OEM model 802 includes one or more modifiable signal attributes. The data type for the model 802 is not set to any specific type and is “inherit: auto”. Upon translating the OEM model 802 by a translator, such as the translator 224, a PVS-specification: post-/pre-condition 804 may be generated. A PVS of a model, as stated earlier, may include the model design implementation in a set of theories. In this particular example, the PVS 804 includes a theory 810 for an example ABS controller used by the OEM model 802. The theory 810 defines a divide condition and parameters to which it applies that divide condition to. As depicted, the parameters have been declared with the type “real” meaning that a parameter can be declared with any real number. In this particular example, there are two requirements that the OEM model 802 must comply with in order to be considered compliant. The first requirement may be that there should be no “division by zero” error upon compilation of the PVS 804. The second requirement may be that the ABS Controller should apply brake when the car is not slipping or is idle. The constrained equivalent verifier 230 may then compile the PVS 804 and verify whether the ABS controller of the OEM model 802 complies with these two requirements. Reference numeral 806 describes verification or proof summary generated by the verifier 230 for the first requirement. As depicted, the proof summary 806 indicates that there was “no division by zero” and hence the first requirement is successfully verified and proved. Reference numeral 808 describes verification or proof summary generated by the verifier 230 for the second requirement. As depicted, the proof summary 808 indicates that the condition “apply brake when not slipping” has been satisfied and hence the second requirement is successfully verified and proved.

FIG. 9 illustrates an example method 900 for verifying an example supplier model 902 with one or more software requirements. As depicted and similar to OEM model 802, the supplier model 902 includes one or more modifiable signal attributes. The data type for the model 902 in this case is not set to “auto” and is set to specific type “uint 32”. Upon translating the supplier model 902 by a translator, such as the translator 224, a PVS-specification: post-/pre-condition 904 may be generated. In this particular example, the PVS 904 includes a theory 910 for an example modified ABS controller used by the supplier model 902. The theory 910 defines a condition for wheel speed gain, where the input(s) to the condition are 32 bit signed integers rather than real numbers defined in theory 810. In this particular example, there are two requirements that the supplier model 902 must comply with in order to be considered compliant. The first requirement may be that there should be no “data overflow” error upon compilation of the PVS 904. The second requirement may be that the ABS Controller should apply brake when the car is not slipping or is idle. The constrained equivalent verifier 230 may then compile the PVS 904 and verify whether the modified ABS controller of the supplier model 902 complies with these two requirements. Reference numeral 906 describes verification or proof summary generated by the verifier 230 for the first requirement. As depicted, the proof summary 906 indicates that there was “no data overflow” and hence the first requirement is successfully verified and proved. Reference numeral 908 describes verification or proof summary generated by the verifier 230 for the second requirement. As depicted, the proof summary 908 indicates that the condition “apply brake when not slipping” has been satisfied and hence the second requirement is successfully verified and proved.

FIG. 10 is a diagram illustrating an example method 1000 for constrained equivalence proof of an example OEM model 802 and an example supplier model 902. The method 1000 may begin by combining the PVS theory of the OEM model 802, the PVS theory of the supplier model 902, and one or more equivalence theorems into a combined PVS 1002 as depicted in the figure. The combined PVS 1002 depicts an example theorem (e.g., a lemma) 1008 for checking constrained equivalence between the OEM model 802 and the supplier model 902. In particular, the theorem 1008 defines a same input 1010 for each of the models and a condition 1012 to test whether the OEM model 902 equals the supplier model 902 based on receiving the same input 1010. In general, reference numeral 1020 depicts a flow for checking constrained equivalence between the two models. The flow 1020 describes that if on providing a same input to each of the OEM model 802 and the supplier model 902, resulting outputs and system states of the models are each equivalent to one another within a specified tolerance limit, then the OEM model 802 and the supplier model 902 may be considered as exhibiting constrained equivalence.

The PVS 1002 may be compiled by the constrained equivalence verifier 230 to determine whether the equivalence theorem 1008 or any other theorems are satisfied/un-satisfied and a proof of equivalence summary 1004 may be generated reflecting that determination. As depicted, the summary 1004 describes that 4 theorems were attempted and all the 4 were succeeded or satisfied. Since all the theorems were determined to be satisfied, the OEM model 802 and the supplier model 902 are proven equivalent as depicted in block 1006, which basically indicates that both the models produced a same output upon giving a same input and that the high-level specification model (e.g., OEM model 802) is equal to the refined model (e.g., supplier model 902).

FIGS. 11A and 11B depict an example OEM model 1100 and an example supplier model 1120, respectively. Referring to OEM model 1100, this model may be created by a hypothetical OEM and represents an automobile anti-lock brake system (ABS) controller. The model 1100 relies upon a bang-bang controller, as depicted in FIG. 11C. The ABS logic in this model is only valid when the driver is depressing the brake pedal. The OEM model 1100 calculates a relative wheel slip between wheels and the vehicle. The definition of the wheel slip is:

$$1 - \frac{Wheel Speed}{Vehicle Speed}$$

The OEM model 1100 uses the following predicate for its ABS logic:

$$0.2 - ( 1 - \frac{Wheel Speed}{Vehicle Speed} ) > 0$$

### Or:

$$\frac{Wheel Speed}{Vehicle Speed} > 0.8$$

Based on the above defined predicate in the OEM model 1100, the vehicle applies the brakes if the wheel slip value is less than 0.2 and releases the brakes if the slip value exceeds 0.2. An important element of the OEM model 1100 is the division block 1102 and the associated check for a zero divisor 1104. The latter block is present to deal with the special case when the vehicle is at rest.

Referring now to supplier model 1120, this model may be created by a hypothetical supplier based on the OEM model 1100 but has been customized based on the supplier's need and hardware. One looking at both the models 1100 and 1120 may immediately notice that these models are quite different from each other. Some of the key points that makes the supplier model 1120 different from the OEM model 1100 are:
1. There is no division in the supplier model, and therefore no need to protect against division by zero condition.
2. The supplier model 1120 uses the following predicate:

10×Wheel Speed>8×Vehicle Speed
The predicates of the OEM model 1100 and the supplier model 1120 are equivalent provided Vehicle Speed #0
3. The bang-bang controller used by the OEM model 1100 has been replaced with its equivalent Simulink blocks.
4. The supplier model 1120 has added logic for dealing with the case when the vehicle is at rest. In this case, the brakes should always be applied.

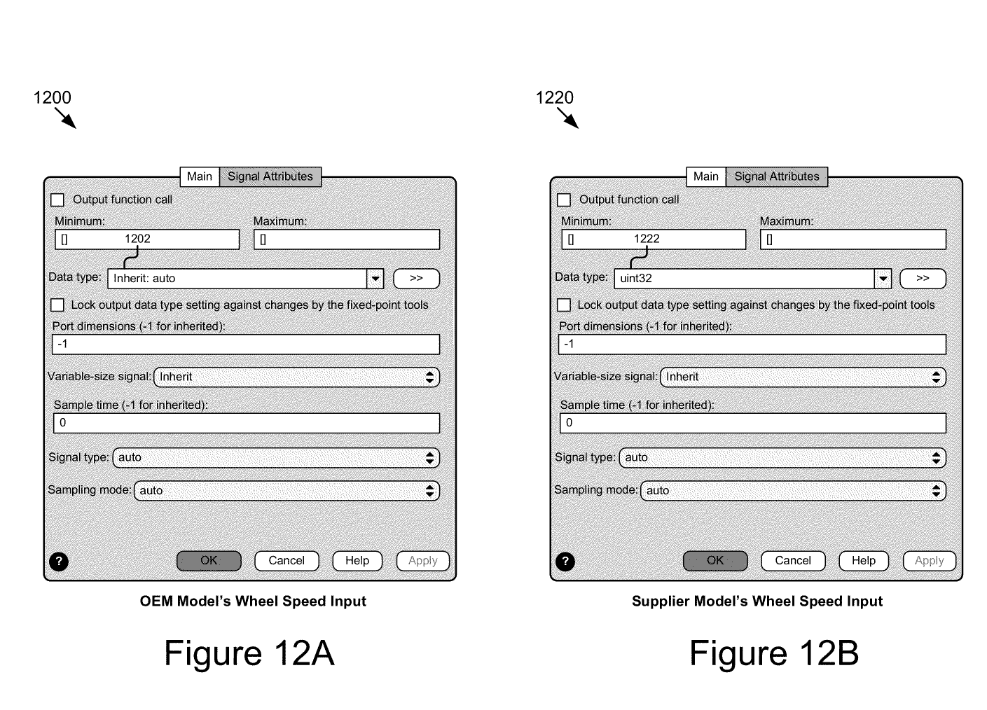

FIGS. 12A and 12B depict wheel speed input parameters used by each of the OEM model 1100 and supplier model 1120, respectively. One looking at both these parameters 1200 and 1220 side-by-side may notice that the OEM model 1100 and the supplier model 1120 also differ from each other by data value types. For example, in the OEM model's wheel speed input parameters box 1200, the data type 1202 is given as “Inherit: auto”, which means that there is nothing known about its actual type and that the wheel speed input can be any real number. On the other hand, in the supplier's model wheel speed input parameters box 1220, the data type 1220 is given as “uint32”, meaning that it can be stored in an 32-bit integer (e.g., its value is between 0 and 2³¹−1).

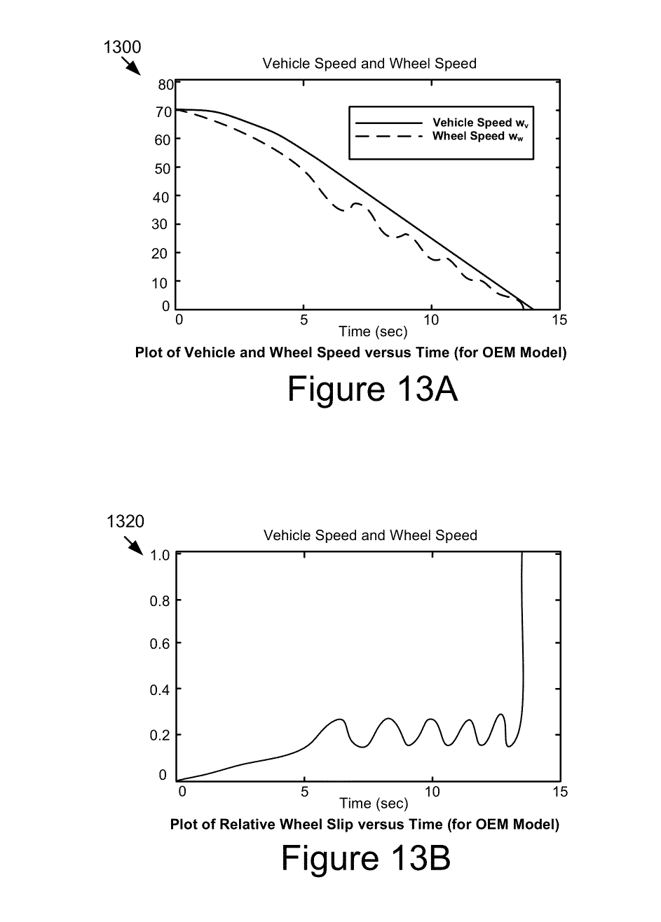

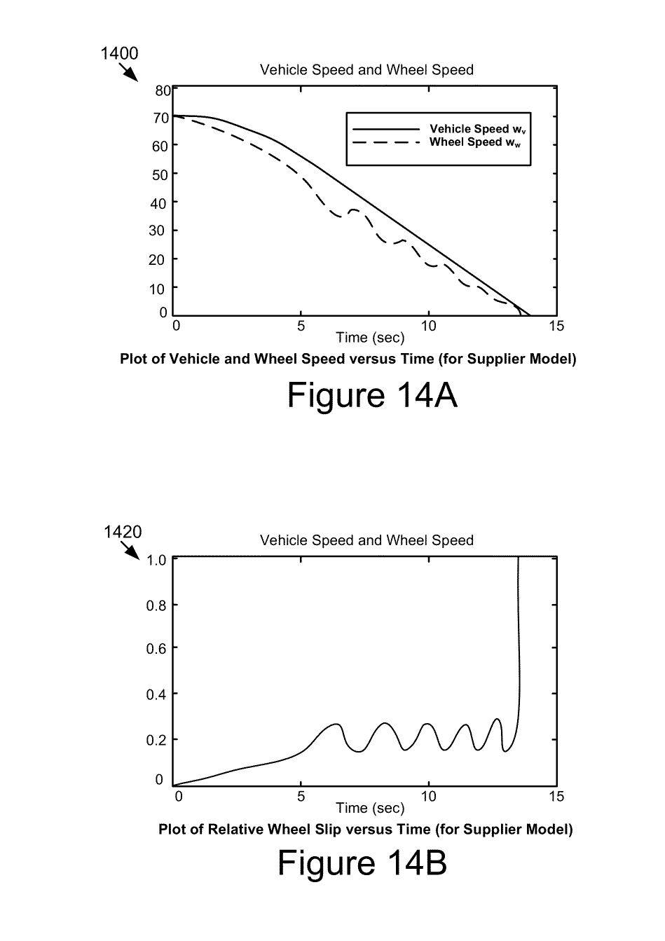

By way of visual illustrations to show any further differences between the OEM model 1100 and the supplier model 1120: FIG. 13A depicts an example plot 1300 of vehicle and wheel speed versus time for the OEM model 1100; FIG. 13B depicts an example plot 1320 of relative wheel slip versus time for the OEM model 1100; FIG. 14A depicts an example plot 1400 of vehicle and wheel speed versus time for the supplier model 1120; and FIG. 14B depicts an example plot 1420 of relative wheel slip versus time for the supplier model 1120. The plots 1400 and 1420 of the supplier model 1120 appear to match the plots 1300 and 1320 of the OEM model 1100. By comparing the plots of the supplier model 1120 with the plots of the OEM model 1100, one would hardly able to figure out any difference between these models and determine accurately whether or not these models are equivalent to each other. This explains another need for performing constrained equivalence check for the two models by the verification engine 113, as discussed elsewhere herein.

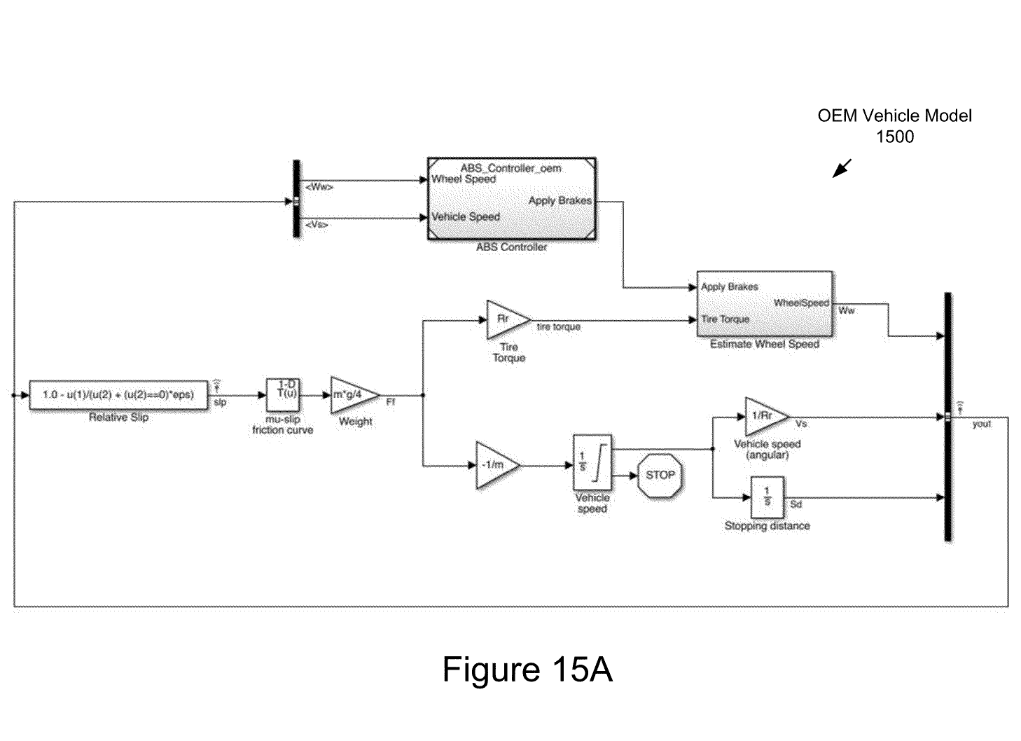

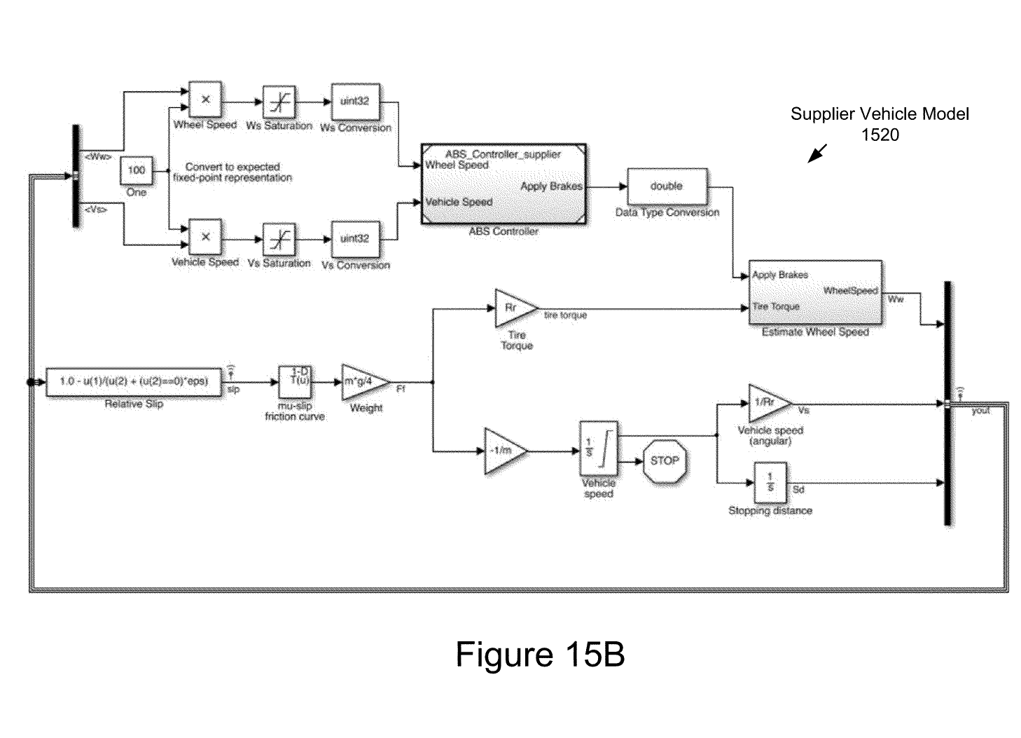

FIGS. 15A and 15B depict an example OEM vehicle model and an example supplier vehicle model, respectively. In particular, FIG. 15A depicts a model 1500 of a vehicle containing an OEM's ABS controller. FIG. 15B depicts a model 1520 of the vehicle containing a supplier's ABS controller. In some embodiments, the supplier's ABS controller may be a modified OEM's ABS controller. In some embodiments, these models 1500 and 1520 may be designed for simulation purposes.

In the above description, for purposes of explanation, numerous specific details are set forth in order to provide a thorough understanding of the specification. It should be understood, however, that the disclosure can be practiced without these specific details. In some embodiments, structures and devices are shown in block diagram form in order to avoid obscuring the description. For example, various embodiments are described primarily with reference to user interfaces and particular hardware. However, the embodiments apply to any type of computing device that can receive data and commands, and any peripheral devices providing services.

Reference in the specification to “an embodiment” or “some embodiments” means that a particular feature, structure, or characteristic described in connection with the embodiment(s) is included in at least one embodiment of the description. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
retrieving, by a verification platform from a non-transitory data storage, a development model and a production model;
translating, by the verification platform, the development model and the production model into formal specifications;
generating, by the verification platform, a set of theorems for checking constrained equivalence between the development model and the production model;
combining, by the verification platform, formal specification of the development model, formal specification of the production model, and the set of theorems into a combined specification; and
proving, by the verification platform, the constrained equivalence based on the theorems.

2. The computer-implemented method of claim 1, wherein proving the constrained equivalence includes proving a theorem establishing the development model and the production model each produces an equivalent output for a particular scenario in response to receiving one or more equivalent inputs.

3. The computer-implemented method of claim 1, wherein proving the constrained equivalence based on the theorems includes:
determining for a theorem, by the verification platform, that one or more inputs to the development model and one or more inputs to the production model are the same or equivalent within a first specified tolerance;
determining for the theorem, by the verification platform, that an output of the development model and an output of the production model are the same or equivalent within a second specified tolerance; and
determining, by the verification platform, the theorem as proven responsive to determining that the one or more inputs to the development model and the one or more inputs to the production model are the same or equivalent within the first specified tolerance, and that the output of the development model and the output of the production model are the same or equivalent within the second specified tolerance.

4. The computer-implemented method of claim 1, further comprising:
approving, by the verification platform, the production model as meeting a particular standard based on proving the constrained equivalence for the development model and the production model.

5. The computer-implemented method of claim 1, further comprising:
generating, by the verification platform, a proof summary describing for each theorem whether the theorem was proven or un-proven for a particular scenario associated with the theorem; and
providing, by the verification platform, the proof summary and a status of constrained equivalence for the development model and the production model to a user device associated with a user for display.

6. The computer-implemented method of claim 1, further comprising:
sending, by the verification platform, a request to a user for providing guidance in proving the constrained equivalence for the development model and the production model;
receiving, by the verification platform, user guidance related to proving the constrained equivalence from a user device associated with the user, wherein proving the constrained equivalence is based on the user guidance.

7. The computer-implemented method of claim 1, further comprising:
prior to retrieving the development model and the production model, verifying, by the verification platform, compliance of each of the development model and the production model with a set of software requirements; and
responsive to determining the compliance, storing, by the verification platform, each of the development model and the production model as a verified model in the non-transitory data storage.

8. The computer-implemented method of claim 7, wherein verifying the compliance of each of the development model and the production model with the set of software requirements includes:
receiving, by the verification platform, the set of software requirements;
translating, by the verification platform, the set of requirements into a formal specification;
translating, by the verification platform, each of the development model and the production model into a formal specification; and
comparing, by the verification platform, the formal specification of each of the development model and the production model with the formal specification of the software requirements to determine whether or not each of the development model and the production model complies with the set of software requirements.

9. The computer-implemented method of claim 1, wherein the development model is an OEM model designed by a manufacturer and the production model is a modified OEM model customized by a supplier according to the supplier's need.

10. The computer-implemented method of claim 1, wherein each of the theorems is one of a type correctness condition, a lemma, and a predicate.

11. The computer-implemented method of claim 1, wherein the formal specification is a prototype verification system (PVS) specification language including a set of theories.

12. A computer-implemented method comprising:
verifying, by a verification platform, compliance of each of a development model and a production model with a set of software requirements;
responsive to the compliance being verified, determining, by the verification platform, each of the development model and the production model as verified and storing each verified model in a non-transitory data storage;
retrieving, by the verification platform from the non-transitory data storage, the development model and the production model determined as verified;
translating, by the verification platform, each of the development model and the production model into a formal specification;
generating, by the verification platform, a set of theorems, each of the theorems proving whether the development model and the production model each produces a same or an equivalent output within a first specified tolerance for a particular scenario in response to receiving one or more same or equivalent inputs within a second specified tolerance;
combining, by the verification platform, formal specification of the development model, formal specification of the production model, and the set of theorems into a combined specification;
compiling, by the verification platform, the combined specification and determining whether each of the theorems is proven based on whether the development model and the production model each produces a same or an equivalent output within the first specified tolerance; and
determining, by the verification platform, the development model and the production model as exhibiting constrained equivalence based on each of the theorems being proven.

13. The computer-implemented method of claim 12, wherein the development model is an OEM model designed by a manufacturer and the production model is a modified OEM model customized by a supplier according to the supplier's need.

14. The computer-implemented method of claim 12, wherein each of the theorems is one of a type correctness condition, a lemma, and a predicate.

15. The computer-implemented method of claim 12, wherein the formal specification is a prototype verification system (PVS) specification language including a set of theories.

16. A system comprising:
one or more processors;
models retriever executable by the one or more processors to retrieve, from a non-transitory data storage, a development model and a production model;
a translator executable by the one or more processors to translate the development model and the production model into formal specifications;
an equivalence theorem generator executable by the one or more processors to generate a set of theorems for checking constrained equivalence between the development model and the production model;
a combiner executable by the one or more processors to combine formal specification of the development model, formal specification of the production model, and the set of theorems into a combined specification; and
a constrained equivalence verifier executable by the one or more processors to prove the constrained equivalence based on the theorems.

17. The system of claim 16, wherein to prove the constrained equivalence, the constrained equivalence verifier is further executable to prove a theorem establishing the development model and the production model each produces an equivalent output for a particular scenario in response to receiving one or more equivalent inputs.

18. The system of claim 16, wherein to prove the constrained equivalence based on the theorems, the constrained equivalence verifier is further executable to:
determine for a theorem that one or more inputs to the development model and one or more inputs to the production model are the same or equivalent within a first specified tolerance;
determine for the theorem that an output of the development model and an output of the production model are the same or equivalent within a second specified tolerance; and
determine the theorem as proven responsive to determining that the one or more inputs to the development model and the one or more inputs to the production model are the same or equivalent within the first specified tolerance, and that the output of the development model and the output of the production model are the same or equivalent within the second specified tolerance.

19. The system of claim 16, wherein the constrained equivalence verifier is further executable to:
approve the production model as meeting a particular standard based on proving the constrained equivalence for the development model and the production model.

20. The system of claim 16, further comprising:
a user interaction module executable by the one or more processors to provide a proof summary and a status of constrained equivalence for the development model and the production model to a user device associated with a user for display, wherein
the constrained equivalence verifier is further executable to generate the proof summary describing for each theorem whether the theorem was proven or un-proven for a particular scenario associated with the theorem.

21. The system of claim 16, further comprising:
a user interaction module executable by the one or more processors to send a request to a user for providing guidance in proving the constrained equivalence for the development model and the production model, the user interaction module is further executable to receive user guidance related to proving the constrained equivalence from a user device associated with the user, wherein to prove the constrained equivalence is based on the user guidance.

22. The system of claim 16, further comprising:
a model verifier executable by the one or more processors to verify compliance of each of the development model and the production model with a set of software requirements and responsive to determining the compliance, store each of the development model and the production model as a verified model in the non-transitory data storage.

23. The system of claim 22, wherein to verify the compliance of each of the development model and the production model with the set of software requirements, the model verifier is further executable to:
receive the set of software requirements;
translate the set of requirements into a formal specification; and
compare the formal specification of each of the development model and the production model with the formal specification of the software requirements to determine whether or not each of the development model and the production model complies with the set of software requirements.

24. The system of claim 16, wherein the development model is an OEM model designed by a manufacturer and the production model is a modified OEM model customized by a supplier according to the supplier's need.

25. The system of claim 16, wherein each of the theorems is one of a type correctness condition, a lemma, and a predicate.

26. The system of claim 16, wherein the formal specification is a prototype verification system (PVS) specification language including a set of theories.

27. A system comprising:
one or more processors;
a models verifier executable by the one or more processors to verify compliance of each of a development model and a production model with a set of software requirements and responsive to the compliance being verified, determine each of the development model and the production model as verified and store each verified model in a non-transitory data storage;
models retriever executable by the one or more processors to retrieve from the non-transitory data storage, the development model and the production model determined as verified;
a translator executable by the one or more processors to translate each of the development model and the production model into a formal specification;
an equivalent theorem generator executable by the one or more processors to generate a set of theorems, each of the theorems proving whether the development model and the production model each produces a same or an equivalent output within a first specified tolerance for a particular scenario in response to receiving one or more same or equivalent inputs within a second specified tolerance;
a combiner executable by the one or more processors to combine formal specification of the development model, formal specification of the production model, and the set of theorems into a combined specification; and
a constrained equivalent verifier executable by the one or more processors to compile the combined specification and determine whether each of the theorems is proven based on whether the development model and the production model each produces a same or an equivalent output within the first specified tolerance, the constrained equivalence verifier is further executable to determine the development model and the production model as exhibiting constrained equivalence based on each of the theorems being proven.

28. The system of claim 27, wherein the development model is an OEM model designed by a manufacturer and the production model is a modified OEM model customized by a supplier according to the supplier's need.

29. The system of claim 27, wherein each of the theorems is one of a type correctness condition, a lemma, and a predicate.

30. The system of claim 27, wherein the formal specification is a prototype verification system (PVS) specification language including a set of theories.
